(19) United States
(12) Patent Application Publication
(10) Pub. No.: US 2008/0044539 A1
(43) Pub. Date: Feb. 21, 2008

(54) ASTRINGENCY-COMPENSATED POLYPHENOLIC ANTIOXIDANT-CONTAINING COMESTIBLE COMPOSITION

(76) Inventors: Daniel Perlman, Arlington, MA (US); Lori Ramonas, West Richland, WA (US)

Correspondence Address: Edward P. Gamson, Suite 2200, 120 S. Riverside Plaza, Chicago, IL, 60606-3945, US

(21) Appl. No.: 11/743,788

(22) Filed: May 3, 2007

Related U.S. Application Data
(60) Provisional application No. 60/746,308, filed on May 3, 2006.

(51) Int. Cl. A23L 3/00; A23L 1/0524; A23L 1/39

(52) U.S. Cl. 426/542; 426/577; 426/589

(57) ABSTRACT

A polyphenoic antioxidant-enhanced comestible composition and method for making it are disclosed. The antioxidant-enhanced comestible preferably includes an astringent amount of exogenous polyphenolic antioxidant dissolved or dispersed in a precursor edible product. The composition also includes an effective concentration of at least one astringency compensating or masking agent sufficient to offset the astringency contributed by the exogenous polyphenolic antioxidant compounds, and can also include an effective amount of at least one protective agent that protects polyphenolic antioxidants from premature oxidation.

### CROSS-REFERENCE TO RELATED APPLICATION

This application claims priority from U.S. provisional application Ser. No. 60/746,308 that was filed on May 3, 2006.

### TECHNICAL FIELD

This invention contemplates compositions, and related methods for providing beneficial polyphenolic antioxidants in comestible products such as jams, jellies, preserves, snack foods, fruit sauces, frozen fruit desserts, beverages including flavored drinks, fruit juices, teas and coffee-containing beverages and combinations thereof without substantially increasing the astringency of the resulting compositions. Some of the contemplated comestibles contain endogenous polyphenolic antioxidants whereas others do not. An aspect of this invention is masking the astringency that results from adding polyphenolic antioxidants to the precursor edible product through the use of an effective amount of an astringency compensating agent or masking agent.

### BACKGROUND OF THE INVENTION

Phenolic and polyphenolic antioxidant compounds, that are the subject of the present invention, are found in grape pulp, skin and seeds, as well as in many other fruits and vegetable materials such as berries, pomegranates, green and roasted coffee beans and various teas. These phenolic compounds include, but are not limited to, the monomeric single ring phenolic compounds, e.g., benzoic and cinnamic acid derivatives such as gallic and coumaric acids, and the polyphenolic compounds such as the two ring stilbene derivatives, e.g., resveratrol, the three ring compounds including the flavonoid derivatives such as the flavanols, flavonols, and anthocyanidins. The catechins are well known flavonoids (flavan-3-ols) that make up as much as 10% of the dry weight of fresh tea leaves.

Tea contains four main catechin substances: epicatechin (EC), epicatechin gallate (ECG), epigallocatechin (EGC) and epigallocatechin gallate (EGCG). Epigallocatechin gallate (EGCG) is the most abundant catechin in tea. The polyphenolics also include more complex ring compounds such as ellagic acid, as well as the oligomeric and polymeric compounds that contain different multiples of the above monomer molecules, and also the acylated and/or glycosylated derivatives of many of these groups of compounds.

Many health benefits have been attributed to the dietary consumption of natural polyphenolic antioxidants owing to the influence of these antioxidants on cellular physiological processes. A partial list of compromised health conditions that are reported to benefit from simply one class of these antioxidants, the proanthocyanidins (aglycolic polymers of anthocyanin), are as follows: heart disease and atherosclerosis, pancreatic inflammation, cancer cell proliferation, kidney, lung and heart cell damage (e.g., damage caused by chemotherapeutic drug treatments). Other polyphenolic antioxidants have been shown to beneficially modulate or control blood platelet aggregation, LDL oxidation, endothelial dysfunction, rheumatoid arthritis and leukemia cell propagation. A bibliography that encompasses much of the recent research (years 2000-2005) involving polyphenolic antioxidants and their role in controlling disease is provided in the book, Muscadine Medicine by Hartle, Greenspan and Hargrove (2005) ISBN Number 1-4116-4397-6.

The antioxidants present in wines and purple grape juices have received a great deal of attention in recent years. Some examples of research involving grape antioxidants are as follows:

1) O'Byrne et al. Am J Clin Nutr (2002) 76(6):1367-1374 who compare two groups of healthy adults consuming either vitamin E (400 IU RRR-alpha-tocopherol) per day or 10 ml Concord grape juice (CGJ) per kg body weight per day for two weeks. Whereas the serum ORAC value (Oxygen Radical Absorbance Capacity) and the resistance of plasma LDL cholesterol to oxidation were increased to comparable extents by both treatments, CGJ was significantly more effective than vitamin E in protecting plasma proteins against oxidation.

2) Frankel et al. J Agric Food Chem (1998) 46:834-838 and Ghiselli et al. J Agric Food Chem (1998) 46:361-367 have shown that the anthocyanin polyphenolic antioxidants in Concord grape juice and red wine strongly retard LDL lipid peroxidation.

3) Freedman et al. Circulation (2001) 103(23):2792-2798 incubated blood platelets with dilute purple grape juice (PGJ). This led to beneficial inhibition of platelet aggregation, enhanced platelet-derived nitric oxide release and decreased oxidative activity (superoxide production). This was confirmed in vivo with healthy human subjects consuming 7 ml PGJ per kg body weight per day for 2 weeks, as platelet aggregation was inhibited, platelet-derived nitric oxide production nearly doubled, superoxide production decreased by about ⅓, plasma vitamin E levels increased and plasma antioxidant status improved.

4) Osman et al. J Nutr. (1998) 128(12):2307-2312 describe the role of platelet aggregation in contributing to atherosclerosis and acute thrombosis formation. Gastric administration of 5-10 ml purple grape juice per kg body weight was capable of reducing platelet aggregation (PA) in both dogs and monkeys, whereas neither orange juice nor grapefruit juice showed such activity. The authors concluded that grape juice is very effective because it contains high levels of the flavonoids-quercetin, kaempferol and myricetin that are known to be effective inhibitors of PA in vitro, whereas the citrus juices contain other flavonoids that are poor inhibitors of PA.

5) Ko et al. J Med Food (2005) 8(1):41-46 evaluated the antioxidant status in human plasma for up to 2 hours following consumption of 150 ml of nine different fruit juices by healthy adult males, using the method of measuring dichlorofluorescein fluorescence whose intensity indicates the level of reactive oxygen species in the plasma. Grape juice was the only juice to exert a persistent antioxidant activity that depressed the fluorescent intensity for over two hours following ingestion.

6) Ariga Biofactors (2004) 21(1-4):197-201 describes the proanthocyanidin antioxidants found in grape seed extracts. These compounds were found to be substantially more active than either vitamin C or vitamin E in aqueous systems, and were shown to slow the progression of a number of diseases in animal models. In a separately published USDA database (www.nal.usda.gov/fnic/foodcomp/Data/PA/PA.html), it has been reported that among a large number of juices and beverages tested, Concord purple grape juice contained the highest concentration of the proanthocyanidins (124 mg per 8 oz serving).

7) Shi et al. J Med Food (2003) 6(4):291-299 describe grape seed waste from production of grape juice in which the seed contains 5-8% polyphenols, mainly flavonoids, including gallic acid, the monomer flavanols catechin, epicatechin, gallocatechin, epigallocatechin, epicatechin 3-O-gallate, and procyanidin dimers, trimers and higher polymers. The antioxidant power of the grape seed polyphenolic proanthocyanidins is claimed to be 20 times greater than vitamin E and 50 times greater than vitamin C.

In recent years, juices made from purple Concord grapes (Vitis labruscana L.) have largely become the quality standard on a worldwide basis because of the grape's balance of sugar, acidity, flavor and aroma. Other dark grape juice cultivars include Fredonia, Van Buren, Sheridan, Ives, Clintonnes and Sunbelt. The U.S. has become the largest consumer of non-fermented grape juice and juice concentrate. In the U.S., Concord grape juice is often blended with white grape juice obtained, for example, from Niagara, Catawaba, Isabella, Ontario and Seneca grapes. In the Southern U.S., a variety of muscadine grapes ranging from black to nearly white are also valued, and are pressed for their juices.

In the production of commercial grape juice, early in the juicing process, the heated grape slurry is enzymatically depectinized, and screen-filtered, permitting recovery of an initial portion of the juice. The warm pressing process releases most of the juice and acidity as well as color (e.g., anthocyanin), particularly in the case of purple grapes. After initially filtering and pressing the grape slurry, some residual insoluble materials in the juice that would cause visible cloudiness (from the skin, seed and pulp that constitute the pomace) are removed from the crude grape juice by methods including decanting, centrifuging and filtering. The resulting clear, single-strength juice is usually pasteurized, and if stored at 35-45 degrees F. typically has a minimum shelf life of 2 years.

Chapter 12 of the FAO Agricultural Services Bulletin 146 published by the Food and Agriculture Organization of the United Nations entitled Principles and Practices of Small and Medium Scale Fruit Juice Processing by Bates, Morris and Crandall provides an excellent background and context for understanding the present invention as it relates to grape juice production. The following is derived from this publication.

The constituents of Concord grape juice that develop during ripening and influence flavor include sugars (mainly glucose and fructose), acids (mainly tartaric, malic and citric), methyl anthranilate, esters, alcohols and aldehydes. The good color stability of Concord grape juice is attributable to the chemical variety of anthocyanins found in the skin of this grape.

As grapes ripen, the percentage by weight of soluble solids (sugars and other constituents) measured in the pressed juice increases. For optimal acidity and flavor, Concord grapes are harvested when the weight percentage of soluble solids falls within the range of 15-18%. Below 15%, the juice contains too little flavor and too much acid, whereas above 18% flavor decreases along with acidity. At a nearly ideal level of 16% by weight (w/w) dissolved solids (technically abbreviated “16 Brix”), a gallon of single strength Concord juice weighs about 8.866 pounds and contains 1.419 pounds of dissolved solids.

In brief, to make Concord grape juice, the grapes are crushed, heated to approximately 60° C. (140° F.), agitated and incubated for some time with pectolytic enzyme to condition the grape pulp for pressing. Initially recovered, so-called “free-run” juice that passes through a mesh screen is combined with juice harvested by pressing the grape slurry. The juice is filtered and/or centrifuged. To eliminate argols (potassium bitartrate) and tartrates that would eventually crystallize and settle out of cooled juice, the harvested juice is heated and cooled again, after which these materials settle out and form a sediment that permits clear juice to be recovered. The juice is bottled and pasteurized for approximately 3 minutes at 85° C.

Single strength grape juice can also be concentrated by vacuum evaporation to make between a 2-fold and 7-fold juice concentrate. Reducing the water content of the juice is economically beneficial because it reduces transportation and storage costs. The process of vacuum-concentration results in the juice's volatile “essence” being stripped and recovered separately from less volatile components of the juice. To restore full flavor, the concentrated essence and juice components are typically recombined. Grape juice concentrates can be packaged, frozen and sold to consumers for dilution at the time of use, or can be shipped in bulk to regional distributors who dilute the concentrate with water, and/or blend it with other juices, before selling the product as single strength juice.

A variety of so-called “natural style” single strength grape juices are commercially available. These can include juices prepared from organically grown grapes, and “not-from-concentrate” grape juices, as well as unfiltered grape juices with varying amounts of insoluble pomace material from the skin, pulp and seeds.

The health-conscious consumer can be attracted to unfiltered grape juices with the expectation that the juice contains higher levels of antioxidants originally localized in the skin and seeds of the grape. Whether this expectation reflects reality is debatable, particularly because many if not most of the antioxidants are water-soluble and extracted into the juice before bottling.

A Concord grape juice sold as Langers Grape Juice Plus is said to contain added Vitamin C and 50 mg of grape seed extract per serving with no added sugar. Presuming the extract is very concentrated (about 80% phenolics), the resulting beverage would contain a minimal enhancement in phenolic antioxidants (about 0.04 g that, when divided by the 240 g serving size, provides about 0.017° by weight of added phenolic antioxidants) and has no apparent remedy for the possible astringency caused by the extract.

Polyphenolic antioxidants from a variety of fruit and vegetable sources can be added as supplementary agents to beverages. However, in order to provide a health benefit, the antioxidants must have adequate chemical stability in the beverage product that is being manufactured for the consumer. Within the past few years, a limited amount of research has focused on the stability of polyphenolic antioxidants in beverages. With regard to pH as a variable, Friedman et al., J. Agric. Food Chem. 2000 48(6):2101-2110 have studied the pH stability of natural plant polyphenols including catechin, gallic acid, epigallocatechin, caffeic acid and ferulic acid among others. Some of these compounds including gallic and caffeic acid were shown to be unstable at high pH.

On the other hand, Zhu et al., J. Agric. Food Chem. 2002 50(6):1700-1705 reported that the very low pH of simulated gastric juice (pH 1.8) as well as mildly alkaline pH can degrade natural dimeric epicatechin-epicatechin structures.

Zhu et al., J. Agric. Food Chem. 2003 51(3):828-833 have also studied the use of an exogenously introduced antioxidant as a sacrificial antioxidant to protect the polyphenolic antioxidants from oxidation. In simulated intestinal juice and phosphate buffer (pH 8.5 and 7.4), it was shown that ascorbic acid, but not citric acid, stabilized both monomeric and dimeric epicatechin antioxidants that would otherwise be degraded at physiological pH. These results suggest that ascorbic acid can be useful in stabilizing flavonols in the intestine before absorption.

In contrast to the Zhu et al. result, Talcott et al., J. Agric. Food Chem. 2003 51(4):957-963 evaluated the stability of different polyphenolic compounds (glycosylated anthocyanins) in grape juice. They showed that ascorbic acid, when added to muscadine grape juice, could be detrimental to juice quality in the presence of another added antioxidant, rosemary extract. When used alone, rosemary formed beneficial complexes with anthocyanins that helped prevent their oxidative degradation. Therefore, it can be necessary to evaluate potential cross-reactivities before adding ascorbic acid as a stabilizer or sacrificial antioxidant to protect polyphenolics.

Tea extracts, as another source of polyphenolic antioxidants, have been used in supplementing beverages. Research in this area is interesting because it is thought that the methods described can have unexpected relevance to the present invention. For example, Ekanayake et al. in U.S. Pat. No. 5,427,806; No. 6,268,009; No. 6,063,428; and No. 5,879,733 describe the processing of green tea extract that initially contains high levels of unoxidized monomeric catechins, epicatechins, epigallocatechins and gallate derivatives. These polyphenolics are unfortunately easily oxidized to form diverse polymers and complexes with other soluble substances in the extract to produce an undesirable brown color, cloudiness, precipitates and altered taste. Dissolved metal ions, as catalysts, and oxygen in the tea extract aggravate this problem.

Ekanayake et al. taught an improved tea extract prepared by extracting the tea with an aqueous acid such as ascorbic plus citric acid, removing the metal cations from the tea extract using a cation exchanger, and passing the extract through a nanofiltration membrane. In addition to containing less than 10 ppm each of Ca, Mg, Mn, Al, Zn and Fe ions, the extract is free of turbidity, contains adequate residual acidity, and contains at least 50 ppm of theanine (5-N-ethyl glutamine). The latter, a natural amino acid derivative present in tea, mellows the taste of the prevalent catechins and their derivatives in the tea extract.

A variety of flavor-modifying agents have been previously used to neutralize bitterness in certain orally administered medicines. McGregor et al. in U.S. Pat. No. 6,942,874, have characterized the role of nucleotides in blocking bitter tastes in medicines, foods and beverages. The blocking agent is reported to bind to taste receptors for bitter agents, and thereby block these agents from attaching to taste receptors where so-called gustducin proteins can be released to trigger the neurosensory pathway signaling bitterness. Other flavor modifiers have been reported in the literature to limit bitterness. These include the cyclodextrins, L-theanine (an amino acid derivative found in tea leaves), and blended flavorants that have been developed as masking agents, e.g., MZ55 Prosweet® natural flavor blend (Virginia Dare, Inc. Brooklyn, N.Y.).

The taste perception of astringency associated with ingestion of phenolic and polyphenolic compounds involves its own chemistry and a neurosensory pathway. This pathway has been reported to differ from that of bitterness. The invention described below provides a palatable aqueous beverage that contains a masked, but otherwise astringent and unpalatable, amount of polyphenolic antioxidant.

### BRIEF SUMMARY OF THE INVENTION

This invention contemplates a palatable, comestible composition (also referred to herein as a comestible product or material or just a comestible), and related methods for providing beneficial polyphenolic antioxidants dissolved or dispersed in a precursor edible product such as a non-beverage food product like a jam, jelly, fruit sauce, frozen fruit dessert (e.g., sorbets and popsicles) or fruit leather, or a beverage like a flavored drink, fruit juice, tea and coffee-containing beverage and combinations thereof. An astringent amount of polyphenolic antioxidant is present dissolved or dispersed in the comestible composition such as a beverage, as is at least one astringency compensating agent that is present in a concentration that is sufficient to mask the astringency contributed by the admixed polyphenolic antioxidant compounds. Thus, a comestible composition is contemplated that comprises a precursor edible product having dissolved or dispersed therein (i) an astringent amount of an exogenous polyphenolic antioxidant and (ii) at least one astringency compensating agent present in a concentration sufficient to mask the astringency.

Although some commercial fruit juices claim to be fortified with antioxidants, these juices typically contain only minimally increased levels of polyphenolic antioxidants, and astringency is not an issue. An astringent amount of exogenously supplied (admixed) polyphenolic antioxidants in a contemplated comestible composition is typically about 0.08 to about 0.0.50 gallic acid equivalent units (GAE) expressed as a weight percentage of gallic acid, that when added to a comestible, renders it astringent. For comparison purposes, the polyphenolic level measured in a typical single strength Concord grape juice has a equivalency of approximately 0.25% by weight gallic acid using the Folin-Ciocalteau assay. Gallic acid is a phenolic antioxidant compound used with the Folin-Ciocalteau reagent to standardize the phenolic calorimetric assay.

A method of producing a polyphenolic antioxidant-enhanced comestible composition from a precursor edible product is also contemplated. A precursor edible product can contain an endogenous polyphenolic antioxidant, but that antioxidant is present in an amount that is below the astringency limit for that precursor so that the precursor is itself palatable. In accordance with that method, a precursor edible product provided and (a) an astringent amount of exogenous polyphenolic antioxidant and (b) at least one astringency compensating agent in a concentration sufficient to mask the astringency contributed by the exogenous polyphenolic antioxidant are dissolved or dispersed in the precursor edible product to form the comestible composition. Ingredients (a) and (b) are dissolved or dispersed separately in either order or together in the precursor edible product.

In a preferred embodiment, the precursor edible product contains endogenous polyphenolic antioxidants and the exogenous polyphenolic antioxidant increases the polyphenolic antioxidant level by approximately about 40% to about 100% of the endogenous amount. In another preferred embodiment, the precursor edible product is a beverage such as fruit juice, tea, or coffee-containing drink.

The endogenous polyphenolic antioxidant level present in a precursor edible product can be readily assayed using the Folin-Ciocalteau calorimetric reagent, and/or by measuring the ORAC level. The level of exogenous polyphenolic antioxidant can be similarly assayed, as can the level of polyphenolic antioxidant present in a contemplated comestible composition.

The present invention has several benefits and advantages.

One benefit of the invention is that by controlling the source and quantity of polyphenolic antioxidant extract that is added to a comestible composition such as a beverage, the beverage's nutritional profile can be greatly improved without greatly increasing the beverage's cost. For example, it is estimated that for a cost of between 2 and 4 cents per 8 oz serving, the polyphenolic content of a fruit beverage can be doubled, while excess astringency can be masked.

An advantage of the invention is that in addition to the polyphenolic antioxidants and astringency masking agents, a sacrificial antioxidant, e.g., ascorbic acid, and/or a chelator, e.g., EDTA, can be added to increase the chemical stability and shelf life of polyphenolics in the beverage.

### DEFINITIONS

In the context of the present invention and the associated claims, the following terms have the following meanings:

The term “diversity” within the context of polyphenolic antioxidant molecules refers to the range and variety of naturally occurring molecular species found in edible fruits and vegetables, including many polyphenolic species that differ in structure and/or abundance from those found in conventionally pressed grape juice, e.g., warm pressed grapes (see above for details). For example, although the predominant polyphenolics in a conventional grape juice can be the glycosylated anthocyanins and other rapidly water-soluble molecular species, the grape pomace skin and seeds contain many small and large aglycone polyphenolic antioxidant molecular species. A number of these “diverse” species, particularly the monomeric and smaller multimeric species such as the anthocyanidins and other aglycone species are absorbed differently, bind differently to cellular receptor cells, and interact differently in the blood stream and within cells, compared to the anthocyanins that are abundant traditional in grape juice.

The term “natural polyphenolic antioxidants” refers to the collective population of molecular species made by plants (and ingested by animals) containing one or more aromatic ring structures having at least one hydroxyl, substituent.

For the purposes herein, the concentration or “percentage by weight” of phenolic or polyphenolic antioxidant is assayed and expressed as an equivalency to a percentage by weight of gallic acid; i.e., gallic acid equivalents or GAE units that are units of concentration. These so-called phenolic or polyphenolic concentrations are measured using a calorimetric assay based upon reacting phenolic/polyphenolic compounds with Folin-Ciocalteau (abbreviated “F-C reagent”).

A gallic acid standard solution (1.00 mg/ml) is used to generate a linear standard curve. Increasing amounts of the gallic acid solution (between 2.5 and 15 μl) are diluted into a series of sample test tubes holding 0.50 ml water. Next, 50 μl of F-C reagent (Sigma Chemical Company) is added to each tube. After 1 minute, but before 8 minutes following addition of the F-C reagent, 0.25 ml of a 15% by weight aqueous sodium carbonate solution is added, the samples are vortexed, and then incubated (maintained) for 2 hours at room temperature. The optical absorbance at 760 nm is read. A sample that is constituted with all chemical components but without gallic acid is also incubated as used as a blank sample to zero the sprectrophotometer (Spectronic 20D+ manufactured by Thermoelectron Corp.). This blank registered an absorbance (optical density or O.D.) at 760 nm of approximately 0.005 above that of distilled water. In the assay, an O.D. 760 nm reading of 1.3-1.4 corresponded to approximately 10 μl of 1.00 mg/ml gallic acid. Also, for reference purposes, a commercial single strength Concord 100% grape juice (Welch's) was shown to have the equivalency in the F-C assay of approximately 0.25% gallic acid (0.25 GAE units).

For the purposes of this invention, the term “polyphenolic antioxidants” and the measured concentrations thereof includes and encompasses any “phenolic antioxidant” that can also be present. This is practical because chemical assay of phenolic chemical groups, e.g., using the Folin-Ciocalteau (F-C) reagent assay, does not distinguish between simple phenolic derivative compounds and more complex polyphenolic structures. For the purposes herein, polyphenolic antioxidants represent all of the phenolic group molecular species (molecular structures) that remain soluble in a juice, e.g., following pressing, filtering and packaging of an anthocyanin-rich grape juice, a colorless (white) grape juice, tea, other juice, or other precursor edible product, for example. These polyphenolic antioxidants can include some molecules that have already undergone a limited amount of oxidation and/or polymerization due to exposure to air, light.

The polyphenolic compounds protect plants from pathogens, serve as UV sunscreens, and can repel hungry animals. As antioxidants, the phenolics can scavenge unpaired electrons (free radicals), inactivate reactive oxygen species, and chelate metal ions that catalyze oxidation. A partial list of prevalent phenolic species include the simple cinnamic and benzoic acid derivatives, the stilbenes (2 phenolic rings), the 3 ring flavonoids (2 phenolic rings plus a flavone ring) that include catechins, flavanols, the anthocyanidins (not glycosylated) and the positively charged anthocyanins of many different structures (glycosylated anthocyanidins having colors ranging from red to blue), and the four ring ellagic acid species and its derivatives as well as a variety of tannins, to name a few.

The term “anthocyanin-rich” in the context of the type of grape juice, refers to a purple or red; i.e., dark colored, grape juice in which a substantial weight percentage (greater than 20% and often greater than 50%) of the polyphenolic antioxidant content of the juice consists of anthocyanins. Anthocyanins are comprised of three ring flavonoid compounds (anthocyanidin) that have been covalently modified with a variety of hydroxyl and methoxyl substituents, and by glycosylation. The molecules carry a single positive charge and are responsible for the intense color of dark grapes and berries. It is believed that anthocyanins and flavonoids more generally, play an important role in controlling inflammatory diseases, allergies and even cancers. Commercial grape juices available in U.S. supermarkets (single strength as well as frozen concentrates) such as Welch's 100% purple grape juice are typically “anthocyanin-rich” grape juices.

The term “oxidation” in regard to polyphenolic antioxidants, refers to degradation of the antioxidants during processing and storage of the juice due to the presence of molecular oxygen dissolved in the juice, exposure to light (photo-oxidation), and the presence of freely reactive prooxidants such as metal cations in the juice. The term oxidation includes secondary degradation of the antioxidants following oxidation, including polymerization that typically causes a decrease in the biological activity of antioxidants.

The terms “Brix scale” and “ORAC value” are defined elsewhere herein.

The terms “supplementary polyphenolic antioxidant compounds” and “complementary polyphenolic antioxidant extracts” refer to chemical mixtures, extracts and concentrates containing natural polyphenolic antioxidant compounds derived from fruit and/or vegetable sources. The extract is “extracted” from fruit or vegetable material using hot water or alternatively, an organic solvent (e.g., alcohol), the latter of which is subsequently eliminated, e.g., by evaporation. As such, the extract does not meet the definition of a “fruit juice” that is defined herein as the natural endogenous liquid (e.g., grape juice) that is released from the fruit when it is initially squeezed or pressed.

As compared to a juice, an extract is often astringent. Being astringent, a complementary polyphenolic antioxidant extract is often added in only small amounts to a fruit juice or other beverage. Compared to grape juice, a grape seed extract for example, includes an abundance of non-anthocyanin polyphenolics.

More specifically, an extract is rich in non-glycosylated (aglycone) polyphenolics such as the catechin/epicatechin family and the procyanidin family. Conventional fruit juices such as cranberry juice or apple juice do not constitute such extracts. However, the antioxidants extracted by heated water from grape pomace, and/or from other fruit and vegetable residues that remain following juicing (e.g., fruit pressing), can provide complementary polyphenolic antioxidants not provided by grape and many other juices.

With a complementary polyphenolic antioxidant, the prevalent molecular characteristics of the antioxidant species (their molecular sizes, degrees of polymerization, flavonoid substituent groups, extents of glycosylation and hydrophobicities, for example), and their biological activities (e.g., rates of gastrointestinal absorption, molecular targets, cellular and/or tissue receptors) differ markedly from the grape juice anthocyanins. For example, the anthocyanins are glycosylated, are poorly absorbed into the bloodstream, and can be complemented by catechins, tannins and polymeric phenols present in a pomace extract. Thus, cranberry pomace and apple pomace extracts can be used to provide complementary polyphenolic antioxidants. This concept is further explained elsewhere herein.

Complementary polyphenolic antioxidant extracts can be prepared from any one (or several) of the “pomaces” of the group including acai, blackberry, black currant, bilberry, blueberry, Camellia sinensis leaves, cherry, chokeberry, cranberry, elderberry, gooseberry, grape, oil palm, raspberry and strawberry. The term “pomace” as defined for the purposes of the present invention, refers to either fruit residues, e.g., the skin and seeds, that remain after juicing of conventional fruit, or to the leaves of tea plants (Camellia sinensis), or to the extract (the non-triglyceride portion) recovered from the fruit of the tropical oil palm. The above extracts are all aqueous extracts.

The term “premature oxidation” that is used in the context of a “protective agent” that limits the amount of undesirable oxidation of polyphenolic antioxidants in the beverage, refers to an extent of oxidation that reduces the polyphenolic antioxidant content of the beverage, as measured in ORAC units [i.e., micromoles of Trolox® equivalents (TE) per gram of sample] by greater than 25% per year when the beverage is stored on the shelf at 20° C.

The term “protective agent” as defined herein, includes any exogenously introduced food additive, or alternatively, any endogenous agent present in the beverage that protects the polyphenolic antioxidants from premature oxidation (such as natural acidity that in Concord grape juice can provide a pH of between 3 and 4, and natural non-phenolic antioxidants such as ascorbic acid that is present in many fruits). Exogenously added protective agents include non-toxic sacrificial antioxidants, chelators of metal ions (e.g., iron and copper chelators), and acids and acid buffers, as further described herein.

Conversely, the term “shelf-stable” in the context of a polyphenolic antioxidant-fortified non-beverage food or beverage such as a tea, fruit leather, tea or grape juice refers to a loss of less than 25% per year in the polyphenolic antioxidant content of the beverage when stored at 20° C.

The terms “grape pomace extract,” “grape seed extract,” and “grape skin extract” are described elsewhere herein. For the purposes of the present invention, hot water extraction followed by centrifugation and/or filtration is the preferred method to be used for obtaining these extract products.

A non-exclusive list of grape species that can used to make the grape juice as well as the complementary polyphenolic antioxidant extracts from skins, seeds and/or pulp includes Vitis labrusca(Concord), Vitis rotundifolia (Muscadine), Vitis vinifera (European wine grape) and combinations of these.

The term “astringency” as used herein is the taste sensation or mouth feel that is most apparent as an aftertaste, and is often described as mouth puckering. Below what is defined herein as the “astringency threshold limit” the taste and mouth feel sensation of astringency is not overly intense, and is typically experienced as a pleasant sensation that helps neutralize excessive sweetness. Conversely, above the astringency threshold limit (abbreviated “A-lim”), the sensation becomes too strong and is unpleasant/undesirable.

Astringency is often associated with the tannin content of immature wines, i.e., wines that are not sufficiently aged. The sensation of astringency is thought to be caused by a reaction between polyphenolic compounds such as the tannins and the so-called PRP proteins (proline-rich proteins) in saliva that are thought to provide wetting, lubrication and protection of the oral epithelium. Research suggests that the precipitation and/or aggregation of complexes formed between the salivary proteins and polyphenols results in loss of oral lubricity-thus the tightened, dry, rough or “puckery” sensation on oral surfaces such as along the sides of the taster's tongue (see Horne et al., jellies, preserves, sauces, sorbets, popsicles, fruit leathers and the like.

“Bitterness” is distinguished from astringency insofar as bitterness is sensed by receptors found in taste buds on the tongue and soft palate. Depending upon the polyphenolic compound being considered, a polyphenolic compound can produce a sensory reaction of either astringency or bitterness, e.g., polyphenolic catechins are often described as bitter whereas tannins are typically described as astringent. There can be differences in perception as well as overlap involving the two sensations of astringency and bitterness. A described presence of one sensation is not intended to exclude the presence of the other. Notwithstanding this duality, most polyphenolic extracts and compounds that are useful in the present invention are experienced as tasting astringent rather than bitter.

The term “astringency compensating agent,” “astringency-masking agent,” or “taste-modifying agent” as used herein refers to a soluble substance or substances that can be added to help mask, neutralize, or compensate either an astringent or a bitter taste caused by addition of the above-described “complementary polyphenolic antioxidant extract” to the beverages described herein.

It is found that the benefit of adding a taste-modifying agent or astringency compensating agent becomes more apparent when the level of complementary polyphenolic antioxidants added to the grape juice or other beverage (increase in ORAC value) is approximately 10-15 units or more per gram of beverage. When the increase in ORAC value is “Turbidity as a Measure of Salivary Protein Reactions with Astringent Substances” in Chem. Senses, 27:653-659, 2002).

A “comestible composition” is an edible processed food that contains an astringent amount of a polyphenolic antioxidant and an astringency-masking amount of an astringency masking agent so that the resulting comestible composition is palatable. A comestible composition is prepared from a precursor an edible product to which the polyphenolic antioxidant and astringency-masking agent are added. Thus, such a composition is something that a human or other animal such as a cat or dog can usually eat without sickness or other injury (comestible), and is made by a person's activity (processed). For example, an orange is not a comestible composition, but orange juice as present in a bottle or other container is man made and can be consumed by a human with usually no ill effect, and is thus an edible precursor. Addition of the polyphenolic antioxidant and astringency-masking agent to the orange juice provides the comestible composition.

A comestible composition can be a solid to semi-solid at ambient room temperature (e.g. about 20° C.) or a pourable liquid at that temperature. A “beverage” is defined as any one of various compositions that are pourable liquids for drinking at ambient room temperature. Illustrative beverages include fruit juice, vegetable juice, tea, coffee, and the like, usually excluding pure unflavored water, although such water can be a beverage herein. A room temperature solid to semi-solid comestible composition is referred to herein as a “non-beverage food”. Illustrative non-beverage foods include jams, approximately 25-35 units or more, the beverage's astringency can be very pronounced, and the benefit of a taste-modifier is even more obvious. Illustrative taste-modifying agents useful in the present invention are the amino acid derivative, L-theanine, and the soluble cyclodextrins (including one or more of the alpha, beta and gamma forms), green coffee bean extract, roasted coffee bean extract and chlorogenic acid. Those compounds can be used either singly or in combination.

Further components that can be considered as ingredients for addition to these comestibles include a non-toxic metal chelator and/or non-toxic sacrificial antioxidant to protect and stabilize the polyphenolic antioxidants in a beverage can be an important feature modification.

The term “non-toxic chelating agent” refers to one or more chemical substances that have the ability to bind and sequester cationic metals that are known to be destructive pro-oxidants when combined in solution with polyphenolic antioxidants described herein. The chelating agent(s) must be edible, and have preferably been approved as a food additive under appropriate government regulations, or have been affirmed by the FDA or self-affirmed as GRAS (generally recognized as safe) after expert review for the intended beverage use, and in the quantities prescribed. A chelating agent binds traces of dissolved cationic iron, copper, magnesium, manganese, zinc, aluminum and some other cations. Two examples of soluble chelating agents are EDTA (e.g. disodium ethylenediamine tetraacetate) and inositol hexaphosphate.

The term “non-toxic sacrificial antioxidant” refers to one or more chemical substances that are selected for the purpose of protecting the polyphenolic antioxidants contributed both endogenously and exogenously to the comestible composition. By being more susceptible to oxidation than the natural polyphenolics, the sacrificial antioxidant is consumed first before an appreciable amount of the more valuable polyphenolics is lost. Examples of these sacrificial antioxidants include vitamin C, rosemary extract, TBHQ, BHA, BHT, propyl gallate and combinations and derivatives thereof that are edible food additives and GRAS (see above) at the levels prescribed by governmental regulations.

The term “non-toxic acid or acid buffer” refers to an edible chemical substance that is generally non-reactive with beverages, and that can establish and maintain an acidic pH in a beverage. For the purposes of the present invention, the acidic pH value range for beverages is generally about pH 2 to about pH 6, and more typically about pH 3 to about pH4. A combination of an acid and an appropriate salt of that acid can provide an “acid buffer”. The non-toxic acid or acid buffer herein is usually based upon any of the following acids: citric, fumaric, lactic, malic, phosphoric, sodium acid sulfate, tartaric acid, as well as salts of these acids, and combinations thereof.

The term “pasteurized” refers to a method of treating edible materials, generally by heating them (alternatively in some instances by gamma irradiating) to a certain point to kill pathogenic microorganisms but not harm the flavor or quality of the beverage. Milk is pasteurized by heating it to about 145° F. (63° C.) for 30 minutes or, using the “flash” method, by heating it to 160° F. (71° C.) for 15 seconds, followed by rapid cooling to below 50° F. (10° C.), at which temperature it is stored. Pasteurization is also used with juices, beer, wine, fruit juices, cheese and egg products. Very stringent flash pasteurization can expose a beverage to a temperature as high as 185° F. for as long as 30-60 seconds. Surprisingly, it has been found that illustrative enhanced beverages such as fruit juices, e.g., Concord grape, fortified with polyphenolic extracts (e.g., grape pomace extracts and grape seed extracts) to increase the total level of phenolic antioxidants 100% or more, can be flash-pasteurized under the above stringent conditions without losing more than 5% to 10% of their phenolic content measured prior to pasteurization.

### DETAILED DESCRIPTION OF THE INVENTION

This invention contemplates compositions, and related methods for providing palatable, comestible composition that contains beneficial polyphenolic antioxidants dissolved or dispersed therein. A comestible composition contemplated herein includes a non-beverage food product such as a jam, jelly, preserve, fruit sauce such as seedless red grape sauce, frozen fruit dessert such as a sorbet or popsicle, fruit snack such as fruit leather and the like, as well as a beverage such as aqueous beverage including a flavored drink, fruit juice, tea and coffee-containing beverage and combinations thereof. A comestible composition is contemplated that is palatable and comprises a precursor edible product having dissolved or dispersed therein (i) an astringent amount of an exogenous polyphenolic antioxidant, and (ii) at least one astringency compensating agent present in a concentration sufficient to mask the astringency contributed by the exogenous polyphenolic antioxidant.

An astringent amount of exogenously supplied (admixed) polyphenolic antioxidant in a contemplated comestible composition is typically about 0.08 to about 0.50 gallic acid equivalent (GAE) units, preferably about 0.12 to about 0.28 GAE units, and more preferably about 0.16 to about 0.24 GAE units.

For convenience in expression and understanding, a contemplated comestible composition is often referred to herein as a beverage such as a fruit juice.

Thus, a precursor edible product such as water that is free of endogenous polyphenolic antioxidants can be cost-effectively fortified with polyphenolic antioxidants and an astringency masking agent. Similarly, a precursor edible product that contains a measurable level of endogenous polyphenolic antioxidants such as a jam, jelly or fruit preserve, fruit snack such as fruit leather, fruit sauce such as thickened or gelled seedless red grape sauce, fruit dessert such as sorbet or popsicles, or a fruit juice such as Concord grape juice or a tea beverage such as green tea, can also be cost-effectively fortified with polyphenolic antioxidants. A contemplated precursor edible product preferably contains at least about 0.05% by weight of endogenous polyphenolic antioxidant compounds (as per GAE measurement), and at least 0.10% by weight of endogenous polyphenolic antioxidants in other embodiments.

The above fortifying polyphenolics are preferably complementary in the sense that they preferably include certain bioactive polyphenolic molecular species not found in the original edible product. For example, a grape seed extract, a fruit pomace extract and coffee bean extract can be added to a fruit juice or tea beverage, or a viniferous grape seed extract or Muscadine grape extract can be added to a Concord grape juice. Accordingly, polyphenolics in the extract can provide health benefits not provided by polyphenolics present in the original edible product. In order for the comestible composition to remain palatable (not excessively astringent), an effective amount of astringency masking agent is also added as explained elsewhere herein.

Taking into account the beneficial effect of adding a masking agent, the amount of polyphenolic extract that can be added to an edible composition is not unlimited, because flavor can be negatively affected, and astringency can re-emerge as a problem if too much extract is added. By tasting gradually increasing amounts of an astringent Concord grape pomace extract added to commercial grape juice, it has been found that astringency is not perceived as a linearly increasing taste sensation. Rather, astringency is initially perceived as a pleasant, slightly mouth-puckering sensation, that increases gradually at first and then, surprisingly, very rapidly with increasing concentrations of polyphenolic extract. Astringency finally becomes excessive and unpleasant as a sensory limit is exceeded.

The total concentration of polyphenolic antioxidants present in a contemplated comestible composition (or product) such as a beverage including fruit juice and tea has been measured as have those levels contributed by supplemental grape pomace extract and tea extract. It was discovered that the palate is unusually sensitive to incremental levels of polyphenolics. Thus, a 50% increase in Concord purple grape polyphenolics added to a regular purple grape juice is perceived by many people as unpleasantly astringent. Similarly, a 50% increase in tea strength (steeping 3 g rather than 2 g per serving of conventional Camellia sinensis tea leaves) is often perceived as too astringent.

This “astringency limit” can be empirically determined by correlating taste with the concentration of phenolics in a comestible composition such as a beverage. The latter can be measured in gallic acid equivalents (GAE units) for example, where gallic acid is a phenolic antioxidant compound used with the Folin-Ciocalteau reagent to standardize the phenolic calorimetric assay.

For the purposes of the present invention, with respect to antioxidant levels, a single strength reference fruit juice is defined as a juice containing that concentration of water-soluble antioxidants present in the native juice as extracted, squeezed or otherwise expressed from the pulp of a single fruit or a mixture of fruits or leaves.

Regarding teas, although there are many differing traditions, arts and methods relating to steeping of teas and making tea infusions (where the amount of loose tea leaves per serving, the water temperature, and the steeping time can differ for different tea varieties, including white, green, oolong, black, pu-erh, flavored and blended teas), for the purposes of this invention the reference concentration of antioxidants for any single strength tea (e.g., for green tea, black tea and others) can be measured after the steeping of between 2.0 and 2.2 grams of any variety of dried Camellia sinensis leaves that have been equilibrated at ambient humidity in 8 fluid ounces of hot water (water initially at 85° to about 100° C. at one atmosphere) for a period of time sufficient to remove most (75% or more) of the antioxidants from the leaves that are extractable into hot water.

The release of total phenolic compounds has been measured during hot water steeping of different teas, and it is found that less than 10 minutes (more typically 5 minutes) of extraction time in hot water (e.g., initially 85° C.-100° C.) is usually sufficient to extract more than 80% of the water-soluble antioxidants from the tea leaves.

Regarding coffee, for the purposes of the present invention, a reference single strength coffee beverage is prepared using two level tablespoons of ground roasted coffee beans (one standard coffee scoop) for each six ounces of brew water. The brew water is preferably heated to a temperature of about 90° C. to about 95° C. for extracting the coffee flavors and antioxidants.

It has been found that polyphenolic extracts derived from different fruit and vegetable sources appear to have different astringency limits; i.e., that amount that when admixed in an otherwise palatable beverage makes that beverage astringently unpalatable. One can taste such extracts diluted into different beverages such as a conventional tea beverage (Lipton Brisk Tea) and a 100% Concord grape juice to obtain an average astringency limit for an extract. Using this method, a Concord grape pomace extract obtained from the skins and seeds of grapes (Fruit Smart, Inc., Prosser, Wash.) appears to have an astringency limit of approximately 0.16% GAE, whereas a very astringent pomegranate extract (Vidya Herbs, Irvine, Calif.) that contains high levels of tannin (30% by weight ellagitannin) has an astringency limit of only approximately 0.02% GAE.

After tasting polyphenolic extracts from a variety of fruit and vegetable sources including pomegranate extract, viniferous grape seed extract and grape skin and seed pomace extract, and tea extract, it has been found that the astringency limit for such extracts can vary at least 20-fold or more, e.g., from 0.01 to 0.2% GAE. Because it is desired to maximize the level of added polyphenolic extracts in beverages without exceeding the astringency limit, these experimentally measured values can be very useful.

The general population would benefit from regularly consuming more fruit and vegetables rich in polyphenolic antioxidants. It is clear that polyphenolic antioxidants are part of a healthy diet. This invention provides beverages that are fortified with polyphenolic antioxidants. Accordingly:

1. If foods such as beverages and other comestibles are to be selected for antioxidant fortification, they should preferably be consumed regularly rather than rarely.

2. Polyphenolic antioxidants in substantial concentrations can be highly astringent. Therefore, a relatively bulky or high volume per serving can permit dilution of the antioxidant to help limit astringency and therefore improve the flavor, and the frequency of consuming the antioxidant-containing product.

3. Sweetness can help control astringency.

4. Oxidation of polyphenolics can be problematic, and neutral to alkaline pH values can exacerbate polyphenolic oxidation, whereas moderately acidic pH values (e.g., pH 3-6) encountered in many fruit products, juices, and the like, can be helpful in minimizing oxidation.

Thus, naturally sweet (or sweetened) foods can be refrigerated, and those that have slightly acidic pH values such as fruit juices can stabilize polyphenolic antioxidants. Often, such comestible compositions contain a variety of endogenous polyphenolic antioxidants. Preferably, these acidic comestibles permit high levels of fortifying polyphenolic antioxidants to be added, dissolved or dispersed, and to remain stable and bioactive. Surprisingly, some antioxidants such as green coffee bean extract or chlorogenic acid can even be used to increase the polyphenolic level in beverages, while decreasing or masking astringency.

Polyphenolic bio-functional and molecular diversity can be provided by using a variety of sources of polyphenolic antioxidants. In principle, such diversity can permit a variety of health conditions to be treated with regular dietary intake of a single fortified beverage fortified using complementary extracts containing multiple polyphenolic antioxidants rather than a single antioxidant chemical. That is, multiple species and classes of polyphenolic molecules from multiple fruit and/or vegetable extract sources can be combined within a single beverage.

An increase of 40%, 50%, and preferably 70% or even 100%; i.e., a doubling, in polyphenolic antioxidant content in comestible composition such as a beverage can be achieved for a cost of between approximately 2 and 4 cents per serving. The cost of producing a beverage ready for bottling is typically about 10 to about 20 cents per 8 oz serving.

Accordingly, the composition and method of the present invention involves combining, in suitable proportions, a comestible composition with an astringent amount of a fortifying polyphenolic antioxidant extract and also an astringent-masking amount of an astringent-masking agent.

Illustrative precursor edible products include jam, jelly or preserves, fruit sauce, fruit leather, water, flavored water, sports drinks such as Gatorade® by PepsiCo, All Sport® by Monarch Beverage Co., Powerade® by Coca Cola, Accelerade® by PacificHealth Laboratories, Lucozade Sport® by GlaxoSmithKline and many others, carbonated drinks, a grape juice, orange juice, pineapple juice, apple juice, grapefruit juice, other fruit juice, or even a tea or coffee-containing beverage. A contemplated precursor edible product is therefore itself palatable and can, and preferably does contain an endogenous polyphenolic antioxidant compound. When so present, the concentration of endogenous polyphenolic antioxidant compounds is below the astringency limit for the precursor edible product.

Illustrative examples of polyphenolic antioxidant extracts include pomace extracts from Concord grapes, cranberry pomace extract, acai extract, pomegranate extract, raspberry leaf and strawberry leaf extracts, Camellia sinensis or tea extract, and combinations thereof.

The polyphenolic antioxidant level resulting in the illustrative grape juice comestible composition (expressed in ORAC units) is increased by at least 40%, and preferably at least by 50%, and more preferably 70% or even 100% or more above the amount of endogenous polyphenolic antioxidant. Where the comestible composition contains less than about 0.05 GAE, the exogenously supplied polyphenolic antioxidant provides an amount sufficient so that the comestible composition has about 0.08 to about 0.50 GAE units, preferably about 0.12 to about 0.28 GAE units, and more preferably about 0.16 to about 0.24 GAE units. Illustrative polyphenolic antioxidant extracts are discussed below.

In preferred practice, a precursor edible product that is to be fortified with polyphenolic antioxidants contains an endogenous antioxidants at a concentration of at least 0.01%, 0.02%, 0.03%, 0.04%, 0.05%, 0.06%, or 0.07%, 0.75%, 0.08%, 0.09%, 0.10%, or 0.11% by weight. The added concentration of polyphenolic antioxidant in a contemplated “enhanced” food product or beverage (comestible composition) is a taste significant concentration, e.g., at least 0.05% by weight polyphenolics based upon added gallic acid equivalents. That is, the concentration of polyphenolics in a composition that contains endogenous polyphenolic antioxidants has an increased reactivity in the F-C assay of at least 0.05% by weight gallic acid after addition of the exogenous polyphenolic antioxidant.

Admixture of exogenous antioxidants increases the polyphenolic antioxidant level by at least 40%, preferably 50%, and more preferably about 60%, 70%, 80%, 90%, 100%, or even more; i.e., doubled, over the endogenous level of polyphenolic antioxidant compounds present in a precursor edible product. The precursor edible product can be a preserve, jam or jelly, or a beverage such as a single strength fruit juice, single strength tea, a single strength coffee or the like as described elsewhere that has not been fortified with antioxidants.

In some embodiments, the supplementary (exogenously supplied) or fortifying polyphenolic antioxidants contribute (in GAE units) about 0.025 to about 0.5% by weight, e.g., about 0.025 to about 0.2%, about 0.05 to about 0.4%, about 0.05 to about 0.2%, about 0.05 to about 0.1%, about 0.1 to about 0.5%, about 0.1 to about 0.4%, about 0.1 to about 0.3%, or about 0.1 to about 0.2% by weight. The astringency compensating agent is added at a level of about 0.01 to about 0.1% by weight of chlorogenic acid (e.g., by adding approximately twice these levels of a green coffee bean extract containing approximately 50% by weight chlorogenic acid), or about 0.015 to about 0.07%, about 0.015 to about 0.06%, about 0.015 to about 0.05%, about 0.015 to about 0.04%, about 0.015 to about 0.3%, about 0.015 to about 0.2%, about 0.02 to about 0.07%, about 0.02 to about 0.06%, about 0.02 to about 0.05%, about 0.02 to about 0.04% chlorogenic acid.

In some embodiments, the supplementary or fortifying polyphenolic antioxidants contribute (in GAE units) 0.025 to 0.5% by weight, e.g., 0.025 to 0.2%, in the range of 0.05 to 0.4%, 0.05 to 0.2%, 0.05 to 0.1%, 0.1 to 0.5%, 0.1 to 0.4%, 0.1 to 0.3%, or 0.1 to 0.2% by weight. The astringency compensating agent is added at a level of 0.01 to 0.1 by weight of chlorogenic acid (e.g., by adding approximately twice these levels of a green coffee bean extract containing approximately 50% by weight chlorogenic acid), or about 0.015 to about 0.07%, about 0.015 to about 0.06%, about 0.015 to about 0.05%, about 0.015 to about 0.04%, about 0.015 to about 0.3%, about 0.015 to about 0.2%, about 0.02 to about 0.07%, about 0.02 to about 0.06%, about 0.02 to about 0.05%, about 0.02 to about 0.04% green coffee bean extract. The supplementary or fortifying polyphenolic antioxidants (in GAE units) are added at a ratio by weight of fortifying polyphenolics:chlorogenic acid of about 2:1 to about 20:1, about 3:1 to about 15:1, about 4:1 to about 16:1, about 5:1 to about 10:1, about 5:1 to about 8:1, about 8:1 to about 20:1, about 8:1 to about 15:1, about 8:1 to about 12:1, about 10:1 to about 15:1 as separately added materials or as a premix containing both the polyphenolic antioxidants and the chlorogenic acid (e.g., as provided by green coffee bean extract). In other embodiments, different astringency compensating agents are used, e.g., as extracts from other sources than green coffee bean extract and/or containing other astringency compensating compounds, in amounts and/or ratios that provide taste equivalent astringency masking as stated for chlorogenic acid (e.g., from green coffee bean extract).

Typical effective concentrations of an astringency compensating agent is about 0.01% to about 0.10%, preferably about 0.01% to about 0.05%, more preferably about 0.03% to about 0.08%, and most preferably about 0.05% to about 0.10% by weight of chlorogenic acid. Where the astringency compensating agent one or both of L-theanine and cyclodextrin, e.g., the effective concentration of astringency compensating agent is about 0.002% to about 0.08% by weight of L-theanine, or about 0.02% to about 0.8% by weight of cyclodextrin. In cases where an astringency compensating agent also provides supplementary polyphenolic antioxidants, such as from green coffee bean extract, the supplementary polyphenolic antioxidants and the astringency compensating agent can be at least in part the same material.

In the course of regular grape juicing operations, an astringent-tasting solid by-product material is left behind that is known as pomace. Pomace consists of skin, pulp and seeds. For many decades, grape pomace was regarded as waste product and was generally used as crop fertilizer or as a component of animal feed. More recently, grape pomace has been used to produce an antioxidant-rich extract by employing a hot water extraction process. The FAO Agricultural Services Bulletin 146 mentioned earlier herein describes this process.

These pomace extracts are typically aqueous concentrates containing about 2% to about 10% polyphenolic compounds, and can be further concentrated to dry water-soluble powders for use in nutritional supplements. The extracts are astringent in taste, and because of this, have been principally used as nutritional supplements in the form of pills and capsules rather than as ingredients of edible products.

Similarly, polyphenol-rich extracts have been prepared from grape seeds alone. Without the presence of grape skins, a substantially anthocyanin-free and color-free extract is produced that can be used to fortify lightly colored, e.g., tea-colored, beverages. Polyphenolic extracts are also obtained from other fruit and vegetable materials such as pomegranates, green coffee beans, tea leaves, raspberry fruit and leaves, strawberries, blueberries, and many other fruits and vegetable sources.

A number of particularly bioactive antioxidant extracts have been selected herein for use in beverages that already contain endogenous polyphenols. These extracts contain a high level of at least one specific and biologically important antioxidant that is rare or altogether lacking in the original beverage. In that manner, an extract from a different and sometimes unique fruit or vegetable extract can be added to the original beverage to obtain multiple health benefits in a single beverage.

It is likely that the health benefit obtained from such antioxidants depends upon the amount added. Accordingly, a particular polyphenol extract is added to a contemplated comestible composition at a level that approaches but does not exceed the astringency limit above which the beverage becomes unpleasant to drink. It has been determined that for Concord grape pomace extract, this astringency limit occurs at an ORAC level (discussed hereinafter) of approximately 50 to about 100 micromoles of Trolox® equivalents (about 50 to about 100 TE) per gram (or milliliter) of beverage.

Additional information on various extracts is as follows:

(i) pomace extract made from Concord grape skin and seeds, is typically rich in anthocyanins, procyanidin dimers, gallic acid, catechin, epicatechin, polymeric phenols (multimer flavonoids and hydrolysable gallic acid-based tannins), caftaric acid and others];

(ii) grape seed extract can be similar to the Concord grape pomace but lacks anthocyanins;

(iii) pomegranate extract is rich in ellagitannin, e.g., extracts can contain 30%-40% by weight ellagic acid;

(iv) green coffee bean extract is rich in chlorogenic acid, e.g., extracts can contain 50% by weight or more of chlorogenic acid;

(v) green tea extract (% by weight) is rich in gallocatechin (2%), epicatechin (6%), epicatechin gallate (14%), epigallocatechin (19%) and epigallocatechin gallate (59%).

As specified by one grape juice processor, Milne Fruit Products, Inc. (Prosser, Wash.), their single strength juices produced for U.S. sale are pasteurized, and are 100% natural, Kosher certified by OU, with no added sodium, preservatives, color or flavor. The juice has a minimum shelf life of 2 years when stored properly at between 35 and 45 degrees F. Their single strength Concord grape juice additionally specifies that it is made from 100% Concord grapes with no artificial ingredients or fillers, with a percentage by weight of soluble solids (Brix reading) of 16±1, a pH value between 2.9 and 3.7, with less than 1% by weight insoluble solids, 0.45-0.80% acidity as tartaric acid, with purple color, good visual clarity, good flavor and aroma and free of fermented, metallic and other off-flavors.

One common measurement provided for the amount of antioxidants present in such juice is the “Oxygen Radical Absorbance Capacity” or ORAC value that is measured in units of micromoles Trolox® [6-hydroxy-2,5,7,8-tetramethylchroman-2-carboxylic acid] per gram of juice being assayed, where one ORAC unit corresponds to one micromole of Trolox®, a water-soluble analog of vitamin E. With regard to antioxidant content, the ORAC measurement for Milne's 5.33-fold concentrated Concord grape juice (68 Brix concentrate) is approximately 150 (micromoles Trolox® per gram of concentrate), with a total measured phenol content of 0.152%. Thus, the calculated ORAC value for regular single strength (16 Brix) juice is 28 and its phenol content is 0.029% by weight.

Another aspect of the present invention contemplates the admixture of an effective amount of at least one astringency compensating (masking) agent to restore palatability to a composition to which biologically beneficial polyphenolic antioxidants that are astringent-tasting are also admixed.

For example, Concord purple grape juice can be fortified with an astringent-tasting pomace extract from the same grape species (see below). As previously explained, this extract obtained from the skin and seeds of the Concord grape contains many antioxidants not found in the regular grape juice. Although the resulting fortified grape juice can benefit from increased antioxidant diversity, its taste can suffer from excessive astringency. For example, increasing amounts of a Concord grape pomace extract has been added to grape juice and other beverages. This pomace extract provided by Fruit Smart, Inc. (Prosser, Wash.) measured 68 Brix for soluble solids and had a polyphenolic content (gallic acid equivalents) of between approximately 6% and 8% by weight.

As an alternative (or in addition) to using Concord pomace extract, the polyphenolic antioxidant diversity of the beverage above or another edible can be increased by adding an extract from a different genus or species of fruit or vegetable. For example, diversity among the bioactive tannin compounds found in Concord grapes is somewhat limited. Tannins, in general, include: (a) the hydrolyzable tannins (HT) such as the gallotannins and ellagitannins, both of which tend to be water-soluble because they are glycosylated and typically contain a central polyol such as glucose), and (b) the more widely distributed condensed tannins, aka the proanthocyanidins (PA), that are non-glycosylated oligomers/polymers of between 2 and 50 or more flavonoid units, often tending to be much less water-soluble (and not hydrolyzed in water), and that when chemically oxidized yield anthocyanidins such as cyanidin and delphinidin.

Within the group of hydrolyzable tannins, gallotannin molecules containing polymers of gallic acid are hydrolyzed to yield gallic acid, a very common species in fruit extracts. The less widely distributed HT subspecies molecules known as ellagitannins are hydrolyzed and dehydrated to the more complex polyphenolic lactone ring compound known as ellagic acid. The ellagitannins are absent in European grapes, but prevalent in a number of other fruits including muscadine grapes, and extracts from pomegranates, raspberries and strawberries. Ellagic acid compounds have been extensively researched and have been shown to provide some health benefits that complement rather than duplicate the benefits provided by Concord grape pomace extract (see bibliography on the bioactivity of ellagic acid in Hartle, Muscadine Medicine, Greenspan and Hargrove (2005) ISBN Number 1-4116-4397-6).

Ellagic acid has been found to exhibit poor solubility in water, whereas a number of different samples of its glycosylated parent subspecies of HT, the ellagitannins (molecular weights typically ranging from 2000-5000), have excellent solubility in water and typical fruit beverages. Samples of ellagitannin-rich extracts containing between approximately 20% and 40% by weight ellagitannin from pomegranates and raspberries have been obtained from Fruit Smart, Inc. (Prosser, Wash.).

Such ellagitannin-rich extracts are preferably and beneficially added in combination with a pomace extract (such as Concord grape pomace extract) for antioxidant diversity. It has been determined that between approximately 50 mg and 75 mg ellagitannin contained in such extracts can be added to an 8 oz (240 cc) serving of fruit juice or tea beverage without contributing excessive taste astringency. Remarkably, if 100 mg, i.e., 0.04% by weight, or more ellagitannin is added to this serving, the perceived astringency jumps dramatically and is unacceptable. No previous report has been found that a sharp and non-linear change, or accelerating increase, in beverage astringency occurs when a threshold concentration of polyphenolic antioxidants is added to a non-astringent-tasting beverage.

Concord grape pomace extracts containing principally non-tannin-type polyphenolic compounds (from skin plus seeds) appear to have a much higher astringency threshold than tannin-rich extracts. For example, an astringency threshold was found to be reached when approximately 1.5% by weight of a Concord grape pomace extract containing approximately 8% by weight total phenols was added to a fruit beverage. Therefore, for a 240 g serving of such a beverage, the astringency threshold for polyphenolics in the pomace extract was approximately 1.5%×8%×240 g=288 mg (approximately 0.12% by weight of the beverage).

The 0.12% value is approximately 3-fold greater than the 0.04% figure for ellagitannin, and can reflect the fact that in the pomace extract, a maximum of approximately 15% of the polyphenolics appeared to be polymeric phenols known to include the tannins (based upon HPLC analysis). It is thus concluded that for polyphenolic tannins, about 100 mg; i.e., approximately 0.04% by weight, is an upper fortification limit based on astringency for an 8 oz beverage serving. However, for non-tannin polyphenolics, the upper fortification limit based on astringency for an 8 oz serving appears to be 3-6 fold higher; i.e., 300 mg (0.12% by weight) or even 600 mg (0.25% by weight). This 0.12% level of fortifying polyphenolics (expressed as GAE) represents between about a 50% and about a 90% increase in phenolic compounds over those originally present in typical commercial 100% grape juice (see the Examples hereinafter).

For Concord grape pomace extract, the astringency threshold is approximately 3-fold greater than the 0.04% figure for ellagitannin, and may reflect the fact that in the pomace extract, a maximum of approximately 15% of the polyphenolics appear to be polymeric phenols known to include the tannins (based upon HPLC analysis). It is reasonable to conclude that for polyphenolic tannins, 100 mg; i.e., approximately 0.04% by weight, is an approximate upper fortification limit based on astringency for an 8 oz beverage serving. However, for non-tannin polyphenolics, the upper fortification limit based on astringency for an 8 oz serving appears to be 3-6 fold higher; i.e., 300 mg (0.12% by weight) or even 600 mg (0.25% by weight). For non-beverage foods, the upper fortification limit can increase to as much as 0.30% or even 0.40% especially for foods that are sweet and/or served cold such as raspberry fruit sorbet.

A non-limiting list of additional extracts that can be beneficially added to fruit juice and tea beverages include (a) grape seed extracts (available from San Joaquin Valley Concentrates, Fresno, Calif.) that are similar to the grape pomace extract but with the notable removal of anthocyanins and some other grape skin-associated antioxidants, (b) pomegranate extract (available from Vidya Herbs, Inc., Irvine, Calif.) that is a rich source of ellagic acid in the preferred form of ellagitannin that is water-soluble. A typical pomegranate extract can contain 30%-40% by weight ellagic acid, (c) green tea extract (available from Vidya Herbs, Inc. Irvine, Calif.) that is a rich source of catechins including principally gallocatechin (2%), epicatechin (6%), epicatechin gallate (14%), epigallocatechin (19%) and epigallocatechin gallate (59%). The typical weight proportions of components are provided in parentheses. It is noted that green coffee bean extract that is a rich source of chlorogenic acid, e.g., extracts can contain 50% by weight or more of chlorogenic acid and can be used as a polyphenolic antioxidant, but green coffee bean extract or chlorogenic acid is preferably used as an astringency masking agent.

It is believed that the absence of grape pomace extract in beverages is due, in large measure, to the very astringent taste of pomace and its history as a waste product. For example, Welch's Inc., the largest producer of grape juice in the U.S. does not produce or sell a grape pomace extract. Rather, the pomace extracts are typically produced by secondary companies that sell the extracts for use as dietary supplements.

The benefit of naturally occurring L-theanine in tea extracts in tempering the potentially bitter taste of natural catechins found in tea beverages has been previously suggested. However, there has been little if any sharing of knowledge between those skilled in the art of processing tea extracts, and those skilled in the art of pressing fruit juices and processing fruit pomaces. In fact, astringency in fruit juices is generally appreciated and well accepted, as is the case with cranberry juice. However, as described below, excess astringency can result when the polyphenolic level of a juice is substantially increased, as evidenced by a substantial increase in the measured ORAC value, e.g., greater than a 50% and as much as a 100% increase in the ORAC value.

It has been found that a limited amount of astringency added to a comestible composition such as a sweet grape juice by a limited amount of polyphenolic antioxidant extract, actually provides an agreeable taste quality. This controlled astringency can help limit the overly sweet aftertaste of a Concord juice, for example, and make the juice more interesting and appealing to an adult palate. More specifically, when a limited amount of pomace extract (or other astringent polyphenolic antioxidant concentrate or extract) is added to a grape juice, the astringency caused by the added pomace extract is limited, whereas the ORAC value of the juice can still be dramatically increased, e.g., by as much as 50%-100%. However, beyond a certain subjective limit, astringency becomes unpleasant.

Notwithstanding the aforesaid approach to astringency, it has been found that there are certain agents including green coffee bean extract, roasted coffee bean extract or purified chlorogenic acid, the various forms of cyclodextrin (alpha-CAS No. 10016-20-3; beta-CAS No. 7585-39-9; and gamma-CAS No. 17465-86-0) and the amino acid derivative, L-theanine (CAS No. 3081-61-6) that can be added to a comestible of the present invention to counteract the mouth sensation of excess astringency caused by a number of the polyphenolic compounds such as the tannins (polymeric flavan-3-ols) and catechins. Use of the cyclodextrins (see above), has been recently described by Iwasaki et al. in U.S. Pat. No. 7,014,876 as a bitterness masking agent for tea extract catechins.

It is found that by adding about 0.02% to about 0.5% by weight of one (or a combination) of the above three structural forms of cyclodextrin, the astringency caused by polyphenolic antioxidants in a comestible composition such as a fruit juice (such as pomace extract-fortified grape juice described herein) can be substantially reduced or “softened.” The alpha-, beta-, and gamma-forms of cyclodextrin are encompassed within the general term “cyclodextrin.”

As noted above, naturally occurring L-theanine (the natural N-ethyl amino acid analog of L-glutamine) has been recognized as an endogenous component in tea leaves (approximately 1%-2% of the dry weight of tea) that limits the astringency of tea. L-theanine has been used in Japan as a flavoring additive, somewhat like MSG, to enhance food flavor—see Internet review article on L-theanine at (delano.com/Articles/Theanine-Sharpe.html).

It is found that by adding approximately 0.002% to about 0.08% by weight L-theanine (about 5 mg to about 200 mg per 8 oz. serving of grape juice), and preferably about 0.004% to about 0.04% by weight L-theanine (10 mg to 100 mg per 8 oz. serving) the astringency of the beverage is substantially reduced or eliminated. L-theanine can be purchased from Taiyo International, Inc. (Minneapolis, Minn.) and from other companies.

A method of the present invention also includes protecting the increased level of polyphenolics by adding a natural or synthetic chelating agent (e.g., inositol hexaphosphate or EDTA) that binds traces of cationic iron and/or copper, and also optionally, adding a sacrificial antioxidant. It is also believed that the natural acidity of purple and other dark-colored grape juices such as Concord grape juice whose pH value can range between approximately 3.0 and 3.5, is helpful for stabilizing polyphenolic antioxidant molecules.

In principle, any dark grape species such as red and purple grapes (collectively termed “purple” grapes herein), whose color is an indicator of substantial concentrations of anthocyanins and that is producing levels of sugar that are comparable to, or at least greater than 50% of that level produced by Concord grapes, including the species Vitis labrusca, (e.g. Concord), Vitis rotundifolia (e.g., Muscadine) and Vitis vinifera (e.g., Cabernet), and combinations thereof can be used to make blended juices of the present invention.

Grape Juice Fortified with Grape Pomace Extract

When compared with Concord grape juice alone, the addition of pomace extract (with or without other fruit extracts) provides a considerably more diverse mixture of polyphenolic antioxidant molecules with regard to molecular size, extent of glycosylation, hydrophobicity, and range of health benefits. The combining of grape juice and grape pomace extract reflects a confluence of the following observations and findings:

(a) Fruit juices such as Concord grape juice are becoming increasingly popular in part because they are known to contain beneficial polyphenolic antioxidants whose health benefit can be similar to that of red wines. Concord grape juice has remained unchanged in its composition for many years. It is thought that Concord grape and other fruit juices can benefit from an enhancement of their nutritional profile, such as by fortification with additional polyphenolic antioxidants.

(b) Given the reputation of Concord grape juice for providing antioxidants, residual antioxidants left behind in the skin and seeds (pomace) when Concord grapes are pressed for their juice have been examined. Several U.S. companies are selling dried and ground grape pomace powders, or alternatively, are extracting the skin and seed pomace to produce a liquid (or optionally dried) extract that is rich in polyphenolic antioxidants. The pomace extract is being sold as a nutritional supplement.

(c) Based on price quotations for Concord pomace extract provided by different companies, and also for regular Concord grape juice, it is found that the grape pomace extract could provide five or six times more polyphenolic antioxidant activity (ORAC units) per dollar than could the grape juice. This surprising finding means that a Concord grape juice can be cost-effectively fortified with enough extract to increase its antioxidant content by 50-100%, while increasing the cost of ingredients by less than 10-20%.

(d) Concord grape pomace extract is known to be highly astringent. Therefore, with our testing of juices, it was not surprising that the astringency of Concord grape juice was dramatically increased by addition of the pomace extract. A Concord grape pomace extract was obtained from Fruit Smart, Inc. in Prosser, Wash. The extract is a 68 Brix concentrate having a total polyphenolic content (measured as gallic acid equivalents) of approximately 6-8% by weight, and an ORAC value of approximately 1250 micromoles Trolox equivalents per gram. When as little as 2% by weight of this extract was added to any one of several different fruit juices, the astringency was judged to be very high and unpleasant. However, a precipitous decrease in perceived astringency was noted as the concentration of pomace extract in the juices was decreased, first to 1.5% and then 1.0%. In fact, with 1.5% added extract, the astringency level was acceptable, and with 1% added extract, the astringency became very mild. At the 1.0-1.5% level, the pomace extract had the effect of pleasantly offsetting excessive sweetness of some fruit juices such as Concord grape.

(e) Tea-based beverages have been studied, and evidence has been found that tea astringency can be controlled by the endogenous amino acid found in tea, L-theanine, and/or by adding cyclodextrin to the beverage. These two chemical agents were tested and found to be quite effective as added ingredients in controlling astringency in grape juice as well.

(f) Other unexpected findings emerged from researching and comparing the chemistry of antioxidants found in the grape juice and the grape pomace extract. Thus, although is was expected that the concentration of all antioxidants present in the pomace extract would exceed those in the grape juice, it became clear that the chemical structures of polyphenolic antioxidants released from the pomace also differed substantially from those present in the juice. More importantly, evidence described below has been found that these differing antioxidants can complement each other in vivo with respect to their rate of absorption in the gastrointestinal tract, and with respect to their biological functions. It is therefore concluded that by combining pomace extract with grape juice, a novel mixed juice composition is created in which not only is the antioxidant potency of the juice increased, but the breadth and diversity of biological activities provided by the mixture appears to be increased.

(g) Mild acidity stabilizes edible polyphenolic antioxidants of biological origin. The natural acidity of grape juice (pH of 3-4) is helpful in providing an oxidation-stabilizing environment.

(i) A chelator, disodium EDTA (ethylenediamine tetraacetate), has been used to protect concentrated reagent phenol from metal-catalyzed oxidation. Therefore, by analogy, rather than using the more difficult and costly method of cation exchange taught by Ekanayake et al. U.S. Pat. Nos. 5,427,806; 6,268,009; No. 6,063,428; and No. 5,879,73 teach the removal of trace metals from tea extract, an effective amount of EDTA [inositol hexaphosphate, diethylenetriaminepentaacetic acid (DPTA), nitrilotriacetic acid (NTA) or other multivalent oxidative metal ion chelator) is added to a beverage to chelate and thereby functionally sequester the catalytic cationic metal pro-oxidants including iron, copper, magnesium and others.

Juice Manufacture and Juice Composition

Concord grapes are typically crushed, mixed together with processing aids that can include approximately 0.7% cellulosic pulp and pectolytic enzyme, and warmed before being initially pressed at a temperature of approximately 130-140° F. to produce a traditional grape juice. This degree of heating of the grape pulp releases only a portion of the water-soluble antioxidants that are originally present in the skin and seeds. Therefore, the pressed pulp or pomace that contains the skin and seeds, also contains a substantial proportion of the antioxidants. It is by subsequent extraction using much hotter water, e.g., at approximately 170° F. or above, that more of the remaining antioxidants can be released to produce the pomace extract.

Substantial amounts of grape pomace extract have not been previously incorporated into fruit juices. After removing (by filtration and centrifugation) all traces of the astringent pomace during the manufacture of sweet Concord grape juice, the idea of adding back any part of the pomace that was just removed would seem counterproductive. However, as described below, it is found that adding back a moderate but not excessive proportion of the pomace extract can be very beneficial.

In recent years, the scientific literature has suggested that different species of polyphenolic molecules can exhibit different biochemical properties and provide different health benefits when consumed regularly in the human diet. It has also been appreciated that a great diversity exists among polyphenolic molecular species synthesized by different grape varieties, and even among the same grape variety harvested at different times of the season.

However, the different health contributions attributable to different classes of polyphenolic antioxidants present in Concord grape juice versus those present in the water-soluble pomace extract from the same grapes have not been exploited. That is, by combining clarified grape pomace extract with grape juice, the molecular diversity and balance in the population of polyphenolic antioxidants can be improved. The resulting pomace-enhanced grape juice can be expected to provide enhanced health benefits.

Although Shrikhande et al. in U.S. Pat. No. 6,544,581 describe a process for extracting polyphenols from either whole grapes, grape seeds or grape pomace, there is no suggestion that the resulting polyphenolic extracts should be combined with other sources of polyphenols (or with one another) to achieve molecular diversity. An obvious difference in the localization of one group of polyphenolic antioxidants within the grape relates to the colored anthocyanins (glycosides). These are highly concentrated in the grape skin, and a substantial amount of anthocyanin material is readily extracted into grape juice.

When comparing grape juice with pomace extract made from the same grapes, it is believed that the considerably higher temperature (e.g., +40° F.) used for producing the pomace extract results in several major differences in molecular populations. First, the higher temperature permits solubilization of approximately 5-10 fold (e.g., 8-fold) more antioxidants into the pomace extract than into the juice, as measured in ORAC units relative to the amount of dissolved grape solids (measured at the same Brix value of 68). Second, it is further believed that the higher temperature and lower sugar concentration during extraction of the pomace yields:

(i) a larger proportion of the aglycolic polyphenol antioxidants that are more hydrophobic and that are poorly soluble at the lower temperatures used for pressing grape juice, and

(ii) a larger proportion of higher molecular weight oligomeric antioxidants that are also poorly soluble at the lower temperatures used for pressing grape juice.

Therefore, grape pomace extracts include the aglycolic proanthocyanidins containing catechin and epicatechin monomer units, plus their oligomeric forms as well as their gallate esters. These molecular species have been found to be particularly effective in promoting endothelium-dependent relaxation (EDR) of blood vessels by increasing nitric oxide release [Fitzpatrick et al., J. Agric. Food Chem. (2000) 48(12):6384-6390].

By contrast, grape juice with its higher sugar content and lower extraction temperature allows solubilization of a higher proportion of the glycosylated and ionic polyphenolics such as the anthocyanins and oligomeric proanthocyanins (OPCs), while helping exclude the more hydrophobic aglycolic polyphenolic antioxidants described above. The anthocyanins have been reported to be particularly effective in protecting LDL particles from lipid peroxidation.

Analytical evidence has been obtained that the above model for molecular partitioning into either the juice portion or the pomace extract portion is essentially correct. More specifically, Frankel has found that the anthocyanins diffusing into the juice from the skin typically account for 60% or more of the polyphenolic content of the juice Frankel et al. J Agric Food Chem (1998) 46:834-838.

Thus, Mazza, Crit. Rev. Food Sci. Nutr. (1995) 35:341-371 and Singletary et al., J. Agric. Food Chem. (2003) 51:7280-7286 have presented data indicating that Concord grape juice anthocyanins are typically dominated by the monoglucosides of malvidin, delphinidin, petunidin, peonidin and cyanidin that account for approximately 60% to 85% of the anthocyanins, whereas the remaining anthocyanins mainly consist of acylated mono- and diglucosides. The anthocyanins have been shown to be potent inhibitors of LDL lipid oxidation [Frankel et al. J Agric Food Chem (1998) 46:834-838 and Ghiselli et al. J Agric Food Chem (1998) 46:361-367].

On the other hand, two independent HPLC analyses of Concord grape pomace extracts obtained from Milne Fruit Products, Inc. (Prosser, Wash.) and Fruit Smart, Inc. (Prosser, Wash.) show a very different picture for the abundance of various polyphenolic antioxidants. Based upon these two pomace extract analyses, the glycosylated flavonoids (including the anthocyanins and the flavonols: myricetin and quercetin glycosides) account for only between 10% and 20% by weight of the polyphenolics, of which the anthocyanins, as mono- and di-glucosides constitute only about 5% to about 15%. Taking 10% as the average, the anthocyanins are only approximately ⅙ as abundant in the grape pomace extract as compared to the grape juice.

By contrast, the non-glycosylated polyphenolics are much more abundant in the pomace extract compared to the juice, accounting for between 80% and 90% of the antioxidants. A diverse mixture of so called “polymeric phenols” is present in the pomace consisting of both non-glycoslated material, e.g., proanthocyanidins (polymers of anthocyanindins) and high molecular weight tannin molecules. The larger anthocyanidin polymers are termed oligomeric procyanidins (abbreviated “OPCs”), and are formed from three or more anthocyanidins). These molecules plus the tannins constitute approximately 40%-60% of the molecular species, whereas smaller procyanidin dimers typically account for about 80%-10%. The [catechin plus epicatechin] (flavanol) molecular species account for approximately 14%-22%, and [gallic acid plus caftaric acid plus minor acid species such as caffeic, coutaric and coumaric acids] constitute approximately 4%-8% by weight.

A comparison of the above molecular species shows that by including a substantial proportion of polyphenolic antioxidant from the pomace extract (i.e., 20%-80% of the total ORAC units contained in the fortified juice), the diversity of molecular species in a grape juice can be greatly increased. The diversity includes a greater proportion of hydrophobic molecular species, and also a greater proportion of higher molecular weight non-glycosylated polymeric polyphenolic species. Specifically, in order to significantly diversify the above-described populations of molecular species in a grape juice blend, the ratio of antioxidant contributions (measured in ORAC units) from pomace extract and grape juice, respectively, in the blend should be about 1:4 to about 4:1. Preferably, this ratio is approximately 1:2 to about 2:1.

Flavonoids are defined by the presence of a flavone ring or its derivative such as the flavanols, e.g., catechin, epicatechin, epigallocatechin and epigallocatechin gallate, and the flavonols, e.g., quercetin, myricetin and their glycosides. The flavonoids also include the colored anthocyaninins, anthocyanidins (aglycolic anthocyanins), and polymers thereof such as proanthocyanidins (polymers of 2-3 catechin (flavanol) molecules) and the oligomeric proanthocyanidins (OPCs or higher polymeric forms of these molecules).

Several chemical properties of these different flavonoid species can determine how much benefit they can provide to human health. For example, the glycosylated polyphenols (more abundant in grape juice than pomace extract) tend to dissolve easily and rapidly in water. They have better chemical stability and shelf life than their aglycone counterpart molecules that are abundant in the pomace extract. However, glycosylated molecules, e.g., the flavonoids, can be less readily absorbed into the bloodstream than their aglycone counterparts.

In the case of the flavonoids, this is because the glycosylated species are absorbed only by active transport, and before active transport can occur several enzymatic alterations are required, e.g., hydrolases remove the sugars before conjugating enzymes either methylate the molecule or add either glucuronic acid or sulfate in place of the original sugar. On the other hand, the less soluble aglycone flavonoids can be directly absorbed into the bloodstream by passive or facilitated diffusion unlike their glycosylated counterparts. Therefore, fortifying grape juice with grape pomace extract that provides substantial amounts of aglycone flavonoids and other aglycone polyphenols that can be more easily absorbed, can be beneficial for increasing the levels of polyphenols in the bloodstream. However, grape juice with its glycosylated polyphenols (requiring hydrolysis, conjugation and absorption into the bloodstream before uptake, deconjugation, and use inside the target cells) can be equally important in extending the time during which the flavonoids and other polyphenols are available for use within the body.

It is believed that by combining the great variety of polyphenolic antioxidants from both grape juice and grape pomace extract, the health benefit obtained from the combination is greater than that of either the juice or the pomace extract separately. It is also contemplated that the antioxidants from the juice and pomace extract be combined in approximately equal proportions based upon their polyphenolic antioxidant activities as measured in ORAC units. A useful range in the proportion of antioxidant contributed by the juice and the pomace extract is about 1:4 to about 4:1, respectively. Preferably, this range is about 1:2 to about 2:1. Most preferably, the proportion is approximately 1:1, e.g., between 1:1.5 and 1.5:1.

The concept that a diversity and balance between the glycosylated and aglycone polyphenols is desirable, as is achieved by combining grape pomace extract with grape juice, is inadvertently supported by the scientific literature. For example, with acai berries, Del Pozo-Insfran et al., J. Agric. Chem. (2006) 54(4):1222-1229 demonstrated that the glycosylated forms of polyphenolic acids and flavanols were more potent in affecting leukemia cell proliferation and cell death in culture than aglycone forms.

It is likely that the glycosylated and aglycone antioxidants found in grape pomace extract and juice components also differ with regard to their anti-neoplastic activities, and if so, a combining of these components would be prudent. Mertens-Talcott et al., J. Nutr. (2005) 135(3):609-614 showed that for leukemia cells grown in culture, the polyphenolic compounds, quercetin (3 ring flavonoid) and ellagic acid (complex 4 ring structure) combined synergistically and beneficially to increase the activation of kinases and induce leukemia apoptosis. If these compounds are distributed differently in grape juice and pomace extract, then their combining can be beneficial.

Composition of Exemplary Tea Beverages

For traditional, i.e., Camellia sinensis-based teas, the reference concentration of antioxidants, e.g., total phenolics, present in a single strength tea can be measured following the brewing of approximately 2.0 grams of Camellia sinensis leaves dried and equilibrated at room temperature and humidity in 8 fluid ounces of water. A survey of a variety of single-use tea bags produced by companies including Lipton, Twinings and Celestial Seasonings shows that these bags contain between 2.0 and 2.3 g dried Camellia sinensis leaves. Sufficient brewing time is allowed to extract most (e.g., 80% or more) of the water-soluble antioxidants from the leaves. Five to ten minutes of brew time in 80-90° C. water has been found sufficient to extract more than 80% of the water-soluble antioxidants from the tea leaves. For the purposes of the present invention, single strength tea is considered a “precursor beverage” whose phenolic antioxidant level is increased at least 50%, and preferably 70% or even 100% or more by additional antioxidants in preparing the “enhanced beverage”.

A simple enhanced tea beverage can be prepared by making double strength tea, e.g., using 4.0 g or more of ambient room equilibrated tea leaves (rather than 2 g) per 8 fl. oz. water as precursor edible product, and correcting for the excess astringency in the beverage using an astringency compensating agent. For example, the Lipton/Unilever company (Englewood Cliffs, N.J.) produces tea bags containing approximately 2.2 g of either green tea (labeled “100% natural”) or black tea (labeled “Brisk” tea). The company claims 190 mg and 175 mg of flavonoids per serving for these green and black teas, respectively. Based upon an 8 oz (240 g) serving, these teas contain 0.079% and 0.073% by weight flavonoids. Accordingly, the double-strength tea beverages (e.g., prepared using 4-4.5 g tea leaves per serving) contain approximately 0.16% and 0.15% by weight flavonoids. These beverages taste very astringent, and the addition of L-theanine (e.g., 10-50 mg per serving), green coffee bean extract (e.g., 100-200 mg per serving), roasted coffee bean extract or other astringency compensating agents as described herein can greatly improve the palatability of these beverages.

Although a precursor edible product composition can contain no endogenous polyphenolic antioxidants (be free of endogenous polyphenolic antioxidants) as in the case of water, in one preferred embodiment, the precursor edible product with which the exogenous polyphenolic antioxidant and taste masking agent are admixed contains at least 0.075% by weight of endogenous polyphenolic antioxidants. More preferably, the precursor comestible contains at least 0.10% by weight of endogenous polyphenolic antioxidants.

A method of producing a polyphenolic antioxidant-enhanced comestible composition from an edible product is also contemplated. In accordance with this method, a precursor edible product is provided and (a) an astringent amount of exogenous polyphenolic antioxidant and (b) at least one astringency compensating agent in a concentration sufficient to mask the astringency contributed by the exogenous polyphenolic antioxidant are dissolved or dispersed in the precursor edible product to form the comestible composition. Ingredients (a) and (b) are dissolved or dispersed separately in either order or together in the precursor edible product. Thus, one can admix ingredient (a) and dissolve or disperse it in the precursor edible product to form a second precursor, and thereafter dissolve or disperse ingredient (b) in the second precursor to form the comestible composition. It is to be understood that ingredients (a) and (b) can also be dissolved or dispersed in the reverse order or they can be premixed with each other and then dissolved or dispersed in the precursor edible product.

In a preferred embodiment, the precursor edible product contains endogenous polyphenolic antioxidants and the exogenous polyphenolic antioxidant increases the polyphenolic antioxidant level by approximately about 40% to about 100% of the endogenous amount, as discussed elsewhere herein. In another preferred embodiment, the precursor edible product is a beverage such as fruit juice, tea, or coffee-containing drink.

A polyphenolic antioxidant and astringency compensating agent premix is therefore also contemplated. That premix comprises (i) a concentrated fruit or vegetable-derived extract containing polyphenolic antioxidant that when mixed with a palatable food causes that food to have an astringent taste, and (ii) at least one astringency compensating agent present in an amount sufficient to mask the astringent taste of the polyphenolic antioxidant when the premix is admixed with a precursor edible product. A contemplated premix can also contain other ingredients such as an effective amount of a protective agent that protects polyphenolic antioxidants from premature oxidation as are discussed below.

In a related aspect, an effective amount of at least one protective agent that protects polyphenolic antioxidants from premature oxidation is included in the enhanced beverage. In one preferred embodiment, a protective agent is a sacrificial antioxidant, a chelating agent or a mixture thereof. Typical concentrations of a chelating agent in the comestible composition (enhanced food product) is about 0.05 mM to about 4 mM, about 0.07 mM to about 3 mM, about 0.1 mM to about 1 mM, about 0.5 mM to about 2 mM, about 1 mM to about 4 mM, about 1 mM to about 3 mM, and about 1 mM to about 2 mM. The concentration of the sacrificial antioxidant in the enhanced food product is about 50 to about 4000 ppm, about 100 to about 4000 ppm, about 100 to about 3000 ppm, about 100 to about 2000 ppm, about 100 and about 1000 ppm, about 500 to about 4000 ppm, about 500 to about 3000 ppm, about 500 to about 2000 ppm, about 500 to about 1000 ppm, and about 1000 to about 2000 ppm.

In another preferred embodiment, the ORAC value of the precursor comestible is at least 20 and the ORAC value of the enhanced comestible is increased at least 50%. In another preferred embodiment, the ORAC value of the precursor comestible is at least 20 and the ORAC value of the enhanced beverage is increased at least 70%.

In another preferred embodiment, the precursor edible product is an aqueous beverage includes a grape juice. For example, Concord purple grape juice is useful because it contains high levels of endogenous polyphenolic antioxidants. Muscadine, red and/or yellow/white grape juice can also be useful in blended compositions.

In another embodiment, the precursor edible product comprises tea(s) made from Camellia sinensis leaves (e.g., extracting the polyphenolic antioxidants with hot water), or fruit juice(s), or combinations of fruit juice(s) and tea(s).

In another preferred embodiment, the exogenous, supplementary polyphenolic antioxidant is provided by an extract selected from the group consisting of grape pomace, grape seed pomace, grape skin pomace, green tea (Camellia sinensis) pomace, green coffee bean pomace, pomegranate pomace, acai pomace, blackberry pomace, black currant pomace, bilberry pomace, blueberry pomace, cherry pomace, chokeberry pomace, cranberry pomace, elderberry pomace, gooseberry pomace, raspberry pomace, strawberry pomace and mixtures thereof. Where a grape extract is utilized, the grape species utilized is selected from the grape species group consisting of Vitis labrusca, Vitis rotundifolia, and Vitis vinifera and combinations thereof.

In a preferred embodiment, the astringency compensating (masking) agent is green coffee bean extract, purified chlorogenic acid, L-theanine, a cyclodextrin or a mixture thereof. Where green coffee bean extract or purified chlorogenic arid is used alone, an amount of astringency compensating agent is admixed to provide an effective concentration of chlorogenic acid that is about 0.008% to about 0.08% by weight of the comestible composition. In another embodiment, the astringency compensating agent is L-theanine, a cyclodextrin or combinations thereof. Preferably, the astringency compensating agent is L-theanine that is present in an effective concentration of about 0.002% to about 0.08% by weight of comestible composition. In another preferred embodiment, the effective concentration of astringency compensating agent is between 0.02% and 0.8% by weight of a cyclodextrin.

In another embodiment at least one protective agent that protects polyphenolic antioxidants from premature oxidation is present, and a chelating agent is included in the enhanced comestible composition that is EDTA or inositol hexaphosphate, or a mixture of both. Preferably, the chelating agent is present at about 0.1 mM to about 2 mM.

In another embodiment, the at least one protective agent that protects polyphenolic antioxidants from premature oxidation is a sacrificial antioxidant selected from the group consisting of vitamin C, rosemary extract, TBHQ, BHA, BHT, propyl gallate and combinations and derivatives thereof. Preferably, the concentration of the sacrificial antioxidant in the comestible composition is about 100 to about 2000 ppm.

In another embodiment, the at least one protective agent that protects polyphenolic antioxidants from premature oxidation is an exogenously supplied acid or acid buffer. In a related embodiment, the acid is selected from the group consisting of citric acid, fumaric acid, lactic acid, malic acid, phosphoric acid, sodium acid sulfate, tartaric acid, edible salts of these acids, and combinations thereof.

In another embodiment, the shelf life of the comestible composition is at least one year at room temperature, in which the ORAC value measured for the enhanced beverage decreases less than 25% during the year. In another embodiment, the comestible composition is heat-pasteurized, and after that pasteurization maintains at least 90% of the total phenolic content measured before pasteurization. Heat pasteurization can be carried out at moderate conventional temperatures, or alternatively at elevated temperatures for shorter exposure periods as described elsewhere herein.

In another aspect, the invention contemplates an antioxidant-enhanced beverage composition that includes endogenous polyphenolic antioxidants and supplementary polyphenolic antioxidants that complement the endogenous polyphenolic antioxidants present in a precursor edible product beverage. The concentration and diversity of polyphenolic antioxidant molecular species in the resulting beverage are increased.

The composition includes: (i) a pre-determined amount of the precursor edible product beverage that contains at least 0.05% by weight of endogenous polyphenolic antioxidant compounds, (ii) an amount of supplementary polyphenolic antioxidant compounds provided in a concentrated fruit or vegetable extract, in which the amount of extract is sufficient to increase both the polyphenolic antioxidant concentration and the ORAC value of the precursor beverage at least 50%, and preferably 70% or even 100%, and (iii) an effective amount of astringency compensating agent sufficient to offset the astringency contributed by the supplementary polyphenolic antioxidant compounds.

In one preferred embodiment, the at least one astringency compensating agent includes an anti-astringent polyphenolic antioxidant compound. In another preferred embodiment, the composition includes an effective amount of at least one protective agent that protects polyphenolic antioxidants from premature oxidation. In another embodiment, the precursor edible product beverage contains at least 0.075% by weight of endogenous polyphenolic antioxidants. In another embodiment, the precursor edible product beverage contains at least 0.10% by weight of endogenous polyphenolic antioxidants.

The present invention also contemplates a new food product. That food product is referred to herein as a seedless grape sauce. The sauce is prepared from sheared or otherwise comminuted whole seedless grapes, e.g., red or purple, and has the viscosity at ambient room temperature of about that of an apple sauce; i.e., the sauce is a spoonable non-ringing gel-like composition. Upon centrifugation or filtration, the sauce can be separated into a pourable liquid portion and a relatively solid portion (pulp and skin). Upon separation of the liquid and relatively solid portions, the liquid portion has a GAE value of at least about 0.1 and more preferably about 0.15 to about 0.5 GAE units of polyphenolic antioxidants endogenous to the grapes utilized in preparing the sauce.

The contemplated grape sauce contains grape skin pieces that are preferably less than about one-quarter inch (about 6 mm) in the longest dimension and more preferably less than about one-eighth inch (about 3 mm). A contemplated seedless grape sauce contains grape skin polyphenolic antioxidants and is free of grape seed antioxidants. As is noted elsewhere herein, those antioxidants can be readily detected, separated and analyzed.

This sauce is preferably thickened by a pectin or other edible thickener such as an agar, gum tragacanth or other polysaccharide thickener. One useful pectin thickener is an amidated low ester pectin is sold under the designation SF 560 pectin by Danisco Ingredients USA, Inc., New Century, Kans.

As is seen from the Examples that follow, seedless grapes cannot simply be sheared or otherwise comminuted to form a contemplated sauce that contains a requisite amount of seedless grape skin polyphenolic antioxidants. Rather, the composition is also typically heated to extract the desired polyphenolic antioxidants from the grape skins. The temperature and duration of heating can be readily determined by a skilled worker, but are sufficient to extract an amount of grape skin polyphenolic antioxidants into the liquid portion that is about 1.5 to about 5 times the amount of antioxidant that is present when the sauce is not heated. The concentration of grape skin polyphenolic antioxidants is preferably at least twice that present in the liquid portion after heating compared to that present prior to heating. In the Examples that follow, a temperature of about 100° C. for a duration of about 1 to about 15 minutes of heating at that temperature provided a desired amount of grape skin polyphenolic antioxidants to the liquid portion of a seedless grape sauce.

A contemplated seedless grape sauce can also be a precursor edible product into which an astringent amount of an exogenous polyphenolic antioxidant can be admixed along with an astringent-masking amount of a masking agent to provide a comestible composition as is discussed elsewhere herein.

Yet another related aspect concerns a method for producing a food composition (beverage or non-beverage) having a reduced sugar to polyphenolic antioxidant compound ratio. Here, an edible precursor product has a predetermined ratio of sugar to polyphenolic antioxidant that can be very high as in a sweetened water drink having substantially no antioxidants to a number that is small as in lemon or lime juices that contain high concentration of antioxidants and little sugar. The sugar-containing edible precursor product (e.g., a fruit juice), is diluted by adding to that precursor edible product (i) exogenous polyphenolic antioxidant compounds, preferably provided in a concentrated fruit or vegetable extract, and (ii) an effective concentration of at least one astringency compensating agent sufficient to offset or mask the astringency of the resulting food composition, e.g., astringency contributed or caused by the supplementary polyphenolic antioxidant compounds. It is to be understood that mere dilution of the edible precursor product with water, for example, dilutes the precursor and the absolute concentrations of sugar and polyphenolic antioxidants, but does not alter the ratio of those ingredients.

In particular embodiments, the precursor edible product is diluted with exogenous polyphenolic antioxidant and astringency-masking agent in sufficient amounts to reduce the sugar to polyphenolic antioxidant compound ratio by at least about 20, 30, 40, 50, 70, or 100%. In certain embodiments, the precursor edible product, supplementary (exogenously supplied) antioxidants, astringency compensating agent(s), and/or resulting food composition are as indicated for embodiments of the first aspect above.

Purple Concord grape juice (obtained from Milne Fruit Products, Inc; Prosser, Wash.), has a typical 68 Brix Concord grape juice concentrate (5.33× concentrate) has an ORAC value of approximately 150 (micromoles Trolox® per gram). Therefore, 16 Brix single strength juice has an ORAC value of approximately 28. By comparison, a 68 Brix pomace extract prepared from the skin and seeds of the same Concord grape variety (obtained from Fruit Smart, Inc; Prosser, Wash.) has an 45-fold greater ORAC value of approximately 1250. By adding just 2% by weight (1:50 dilution) of the concentrated pomace extract to purple Concord grape juice as precursor edible product, the ORAC value of the resulting comestible composition juice mixture is increased approximately 50%-100%. That is, 2%×1250=25 ORAC that approximates the 28 ORAC value for the single strength grape juice.

A quart of the single strength Concord juice (approximately 1006 g) containing approximately 28,000 ORAC antioxidant units costs approximately 35-40 cents, whereas the amount of pomace extract (20 g) also containing 25,000 ORAC units costs less than 7 cents ($3.40 per kg). Thus, surprisingly, the level of antioxidant present in approximately 40 cents of Concord grape juice (1 quart) as precursor edible product can be doubled with only 7 cents of pomace extract in the formation of a contemplated comestible composition. Where it is desired to increase the ORAC value of the juice by about 50%, a 3.5 cent increase in cost represents an increase of less than 10% over the cost of the original juice.

The added pomace extract antioxidants as well as the endogenous grape juice antioxidants are preferably protected against oxidative degradation. This is preferably achieved by adding a chelating agent that binds cationic iron, and optionally a sacrificial antioxidant.

Accordingly, in addition to combining:

(i) a conventional grape juice, such as warm-pressed Concord purple grape juice as precursor edible product, and

(ii) a concentrated polyphenolic antioxidant extract obtained from grape pomace solids [in which this antioxidant extract contains a concentration of polyphenolic antioxidants at least ten times greater, and preferably 20 to 40 times greater than that of the single strength grape juice provided in (i) above],

further additions can optionally include:

(iii) at least one chemical compound that chelates cationic iron, and

(iv) at least one chemical compound that serves as a sacrificial antioxidant such as rosemary extract or vitamin C.

Polyphenolic antioxidants present in this fortified grape juice comestible are also protected from oxidative breakdown by maintaining the acidic pH of the juice, and by the presence of a chelator such as inositol hexaphosphate or EDTA that sequesters metal ions such as iron and copper cations that are pro-oxidants.

Extractable antioxidants and other nutrients that remain in the pomace following grape juice pressing, including residual polyphenolics present in the skin and seeds, are viewed herein as beneficial constituents of the grape, that belong in a natural grape juice. By way of comparison, when whole grapes are eaten, or when whole grapes are blended to produce a fruit smoothie, the digestive system with its acid and array of enzymes and emulsifiers has the opportunity over a period of hours to extract most of the water-soluble material from the pulp, skin and part of the seeds. These compounds can include the larger, less soluble and slower to dissolve polymeric polyphenolic antioxidants, some of which can be biologically active to provide unanticipated health benefits. Therefore, the present invention contemplates producing a nutritionally improved grape juice or other fruit juice as a comestible composition that is substantially free of pomace solids, but that is supplemented with an extract from grape or other fruit pomace that contains an increased concentration and an increased diversity of antioxidant compounds.

A grape juice comestible composition of this invention is produced by recombining a conventionally produced grape juice as precursor edible product, e.g., a warm-pressed Concord purple grape juice, with a higher temperature water extract of the grape pomace to and a suitable amount of masking agent to produce the comestible composition. The pomace extract contains some antioxidants that differ in structure and/or relative abundance from those present in the grape juice, as well as other water-extractable compounds not present in the pulp-derived grape juice. The amount of pomace extract added to the grape juice is sufficient to increase either the total polyphenolic compound content or the ORAC (oxygen radical absorbance capacity) value for the grape juice by at least 40%, and preferably 50%, 70%, 100% or more, up to a limit of 400%.

The above measurements are based upon natural endogenous grape antioxidant levels and not upon measurements artificially elevated by addition of exogenous antioxidants such as vitamins C and/or vitamin E. Accordingly, if a typical single strength filtered Concord purple grape juice as precursor edible product contains a total of 0.20% by weight natural polyphenolic compounds (expressed as gallic acid equivalents) and has an ORAC value of 28 micromoles Trolox® per gram of juice, the added extract increases the phenolic value to at least 0.0280- and the ORAC value to at least 39.

In addition, to protect the polyphenolic antioxidants from premature oxidation and thus to increase the shelf life of the juice, at least two other ingredients are preferably added. First, a sacrificial antioxidant (preferably from a natural source rather than chemically synthesized) is added, such as rosemary extract or ascorbic acid, i.e., vitamin C, at a level of approximately 60-120 mg per serving (1-2 times the Recommended Daily Allowance). A moderately acidic beverage environment (pH 2-5, and more typically pH 3-4) also favors protonation of the multiple phenolic oxygens in polyphenolic antioxidant molecules, thereby preventing the formation of phenoxide free-radicals that can attack, oxidize and decompose the molecules.

It is believed that addition of a metal ion chelator to grape juice can enhance the stability of polyphenolics contained in the juice by protecting the polyphenolics against degradation by the most common pro-oxidant cations (iron and copper). For this purpose, a metal cation chelator is added. For example, either disodium EDTA (ethylenediamine tetraacetate) or phytic acid (inositol hexaphosphate) can be added. EDTA is a synthetic food additive compound that is GRAS approved under FDA regulations, and phytic acid is a natural product typically purified from grains such as rice hulls. The strong affinity of EDTA and phytic acid for dissolved iron cations has been demonstrated by their ability to deplete iron and cause anemia when fed to animals. A concentration of about 0.1 mM to about 5 mM of either chelator is recommended for addition to the grape juice. Preferably, a concentration of about 0.025 mM to about 2 mM, and more preferably, a concentration of approximately 0.05 mM is preferred.

### EXAMPLE 1

### Fortified Fruit Juice and Tea Plus Coffee

Fruit juices and teas fortified with phenolic antioxidants were prepared and tasted. Illustrative fortified beverages contained twice their respective reference levels of total phenolic antioxidants for these beverages, e.g., for both 100% Concord grape juice and for black and green tea. Such polyphenolic antioxidant fortification (e.g., adding grape seed extracts, grape pomace extracts, pomegranate tannin extracts, and tea extracts/concentrates) typically produces unpalatable beverages with an unpleasantly astringent taste, and did so here. Such excess astringency in fruit and tea beverages has certainly discouraged the commercial use of such high levels of polyphenolics even if those levels provide health benefits and advantages over the reference beverages.

Notwithstanding this history, it has unexpectedly been discovered that an unpalatable double-strength brewed green tea (prepared by steeping approximately 4 grams of green tea leaves rather than 2 grams per 8 oz heated water per serving) could be restored to palatability by adding a small amount of brewed coffee.

This study and others that followed were conducted as follows: Several tea beverages were prepared using Lipton (Unilever Company, Englewood Cliffs, N.J.) tea bags brewed in 8 oz. hot water (10 minute brewing at approximately 85° C.). The tea bags contained approximately 2.2 g of either green tea or black tea as described elsewhere herein. These single strength teas are reported by Lipton to provide 190 mg and 175 mg of flavonoids, respectively, per serving. Based upon an 8 oz (240 g) serving, these teas contain concentrations of 0.079% and 0.073% by weight flavonoids. Green and black teas were prepared using either one or two tea bags per serving. No sugar or any other ingredient was added.

Although the “one bag” teas were pleasant and non-astringent, the “two bag” teas (also referred to as “double strength” or “2× teas”) were unpalatable. Conventional coffee (Starbucks French Roast “Extra Bold”) was separately brewed, using 1 tablespoon of freshly ground coffee per 6 oz water. Increasing amounts of the coffee were added to the 2× green tea, and the resulting blended beverages were tasted. When the ratio of coffee to 2× tea reached approximately 1:3, the astringency of the tea dropped dramatically. Very little astringency remained as the ratio of coffee to 2× tea was raised to 1:2. This blend had a reasonably pleasant flavor described as half way between coffee and tea. The study was repeated with similar results using 2× black tea (Lipton) in place of 2× green tea.

A search of the worldwide web produced one reference that described coffee and regular strength tea that had been combined in Asia in a beverage known as “Yin Yang.” There is no suggestion that the regular tea and coffee components in Yin Yang taste astringent, nor that they are brewed using higher than normal levels of ingredients.

The components of coffee beans were investigated by obtaining a sample of a dried water extract from green coffee beans (referred to herein as green coffee bean extract or GCBE) from Vidya Herbs, Inc. (Irvine, Calif.). This dried extract (also available from a number of other companies including Stella Laboratories, Paramus, N.J.), contains approximately 50% by weight chlorogenic acids (a mixture of molecular forms of these polyphenols), and an overall total of 65% by weight polyphenols.

Increasing levels of GCBE were added to the unpalatably astringent 2× green and 2× black teas described above. With the addition of approximately 100 mg of GCBE per 8 oz serving of these teas (preferably about 150 mg per serving), their astringencies greatly diminished and they became surprisingly palatable. Remarkably, no prior evidence has been found in the literature to suggest that either GCBE or chlorogenic acids or any other polyphenolic compound can mask astringency.

Exploring the astringency-masking properties of GCBE further, a highly astringent viniferous grape seed polyphenolic extract known as Activin® (San Joaquin Valley Concentrates Inc. Fresno, Calif.) was combined with single strength Lipton teas. The Activin® was added at a level of 0.1% by weight to both green and black teas (brewed as described above) to produce astringent beverages. This level of Activin® grape seed extract was sufficient to increase the total polyphenolic concentration of the teas by more than 100% (200 mg per serving contributed by the Activin® and 175-190 mg from the teas). Addition of green coffee bean extract (150 mg per 8 oz. serving) again dramatically reduced astringency, providing very palatable polyphenol-fortified teas.

It is both significant and surprising that the GCBE, which is itself a polyphenolic antioxidant extract, can reduce or mask the astringency of other polyphenolic compounds. Although not wishing to be bound by theory or hypothesis, it is thought that chemical compounds found in green coffee bean extract (and regular brewed coffee prepared from roasted arabica beans contains between 70 and 200 mg chlorogenic acid per 200 ml cup, whereas a similar cup from roasted robusta beans contains between 70 and 350 mg) inhibit the normal sensory pathway stimulated by most polyphenolic compounds found in tea, grape seed and grape pomace extract that are perceived as astringent.

One or more of these compounds is thought to be from the chlorogenic acid family of polyphenolic antioxidants that have been shown to be bioactive. That is, the chlorogenic acid family of polyphenolic antioxidants has been shown to provide important health benefits (see review cited herein, Hartle, Muscadine Medicine, Greenspan and Hargrove).

### EXAMPLE 2

### Concord Grape Juice (CGJ) Fortified with Concord Grape Pomace Extract

One hundred percent Concord purple grape juice (Welch's, Concord, Mass.) that was shown to contain approximately 0.20% by weight polyphenolics (F-C assay) was supplemented with between zero % and 4% by weight of 68 Brix concentrated Concord grape pomace extract obtained from Fruit Smart, Inc. (Prosser, Wash.). The pomace extract, having an ORAC value of more than 1250 micromoles Trolox® per gram, and containing approximately 8.2% by weight total phenolics (F-C assay), was blended into the CGJ with stirring. All of the resulting blended purple grape juices had excellent clarity and fragrance, with increasing levels of astringent mouth feel as indicated:

| | Added | | | |
|---|---|---|---|---|
| Juice | Extract | Estimated | | |
| number | (% by Wt.) | ORAC | GAE | Astringency |
| 1 | zero | 28 | 0.20 | none, very sweet |
| | | | | aftertaste |
| 2 | 1 | 41 | 0.282 | noticeable in |
| | | | | aftertaste |
| 3 | 2 | 53 | 0.36 | moderate to strong |
| 4 | 4 | 78 | 0.52 | excessive/unacceptable |

### EXAMPLE 3

### Concord Grape Juice (CGJ) Fortified with Concord Grape Pomace Extract Plus 0.5 mM Disodium EDTA (Na₂ EDTA)

The fortified grape juices prepared as in Example 2 were supplemented with a chelating agent at a concentration of 17 mg per 100 ml CGJ (0.5 mM disodium EDTA). This level of chelator was deemed sufficient for complexing traces of cationic iron and copper that might otherwise catalyze the oxidation of polyphenolic compounds in the CGJ.

### EXAMPLE 4

### Concord Grape Juice (CGJ) Fortified with Concord Grape Pomace Extract Plus 0.5 mM Inositol Hexaphosphate

The fortified grape juices prepared as in Example 2 were supplemented with a different chelating agent at a concentration of 66 mg per 100 ml CGJ (1.0 mM inositol hexaphosphate). The inositol hexaphosphate (purified from rice hulls) was purchased as a 50% by weight aqueous solution from Charles Bowman and Company (Holland, Mich.). This level of chelator was deemed sufficient for complexing traces of cationic iron and copper that might otherwise catalyze the oxidation of polyphenolic compounds in the CGJ.

### EXAMPLE 5

### Concord Grape Juice (CGJ) Fortified with Concord Grape Pomace Extract 0.5 mM NA₂ EDTA and Sacrificial Antioxidant

The fortified grape juices prepared as in Example 2 were supplemented with a chelating agent at a concentration of 17 mg per 100 ml CGJ (0.5 mM disodium EDTA). This level of chelator was deemed sufficient for complexing traces of cationic iron and copper that might otherwise catalyze the oxidation of polyphenolic compounds in the CGJ. In addition, ascorbic acid was added as a sacrificial antioxidant at a level of approximately 25-50 mg per 100 g CGJ or between 60 and 120 mg per 8 oz serving (1-2 times the Recommended Daily Allowance of vitamin C).

### EXAMPLE 6

### Concord Grape Juice (CGJ) Fortified with Concord Grape Pomace Extract and L-Theanine to Control Astringency

A CGJ beverage was constituted as in Example 2 (see juice #3) by adding 21 Concord grape pomace extract to Concord grape juice. This level of pomace extract approximately doubled the ORAC level of the original grape juice. The pomace extract-fortified grape juice was supplemented with L-theanine to provide about 5 mg to about 200 mg per 8 oz juice serving; the L-theanine was obtained from Taiyo International, Inc. (Minneapolis, Minn.). L-theanine was freely soluble in the grape juice and, with a suitable amount added, e.g., 50 mg-100 mg, substantially reduced the organoleptic astringency of the polyphenolics in these juices. Amounts of L-theanine less than approximately 20 mg per 8 oz serving were judged marginal to inadequate for controlling the astringent taste of juice #3.

### EXAMPLE 7

### Concord Grape Juice (CGJ) Fortified with Concord Grape Pomace Extract and Cyclodextrin to Control Astringency

The protocol of Example 6 was repeated except that instead of adding L-theanine to the fortified CGJ, the juice was supplemented with “Cavamax® W7” beta-cyclodextrin (50 mg-1500 mg per 8 oz serving of juice). The cyclodextrin was obtained from Wacker Chemical Corporation (Adrian, Mich.), and dissolved in the fortified CGJ. Astringency decreased with increasing levels of cyclodextrin. In particular, as levels were increased from 500 mg per serving (0.2% by weight of CGJ) to either 1 g or 1.5 g per 8 oz serving (0.6% by weight of CGJ), the astringency decreased very noticeably.

The benefit of adding both L-theanine and beta-cyclodextrin to control astringency was also examined. Accordingly, an 8 oz serving of the same pomace extract-fortified CGJ used in Examples 6 and 7 was supplemented with 600 mg beta-cyclodextrin plus 50 mg L-theanine. Following dissolution of these additives in the fortified CGJ, astringency of the beverage decreased very noticeably.

### EXAMPLE 8

### Concord Grape Juice (CGJ) Fortified with Concord Grape Pomace Extract and Pomegranate Extract

A CGJ beverage was constituted as in Example 2 (see juice #2) by adding 1% by weight Concord grape pomace extract to Concord grape juice. In addition, to each 8 oz (240 g) serving, 160 mg pomegranate extract was added as a complementary polyphenolic antioxidant to provide ellagic acid (obtained from Vidya Herbs, Inc., Irvine, Calif.). This extract contained approximately 50 mg (30% by weight) ellagic acid (as ellagitannin). The resulting beverage tasted excellent without excessive astringency and, when tested for antioxidant activity, had an ORAC value of 73 (over twice the 28 ORAC value for regular 100% CGJ).

### EXAMPLE 9

### Concord Grape Juice (CGJ) Fortified with Concord Grape Pomace Extract and Green Coffee Bean Extract

Two different sources of 100% Concord purple grape juice (Welch's Concord, Mass. and Fruit Smart, Prosser, Wash.) were assayed for total phenolic content (Total Phenolics) expressed as weight percentage of the juice measured as catechin equivalents using the ferric chloride method. Samples of the Fruit Smart juice were also supplemented with 1.5% by weight Concord grape pomace extract (see Example 2), with and without the addition of green coffee bean extract (GCBE, 100 mg and 200 mg per 8 oz serving) obtained from Vidya Herbs, Inc. (Irvine, Calif.). Paradoxically, the GCBE, a polyphenolic antioxidant, was found to reduce and help mask the astringency contributed by the pomace extract, while also contributing an additional antioxidant to the beverage.

The ORAC tests measuring peroxyl radical water-soluble antioxidant activity of the juice samples were carried out by an independent testing laboratory (Brunswick Laboratories, Wareham, Mass.) and are reported below. Abbreviations: Welch's 100% grape juice (Welch's); Fruit Smart 100% Concord grape juice (FS); Concord grape pomace extract (PE); green coffee bean extract (GCBE); not done (n.d.); Trolox®

| | | Total | | |
|---|---|---|---|---|
| | | Phenolics | % Increase | ORAC |
| Juice | | (Wt %) | vs. Welsh's | (μmole TE/g) |
| 1. | Welsh's | 0.128 | zero | 26 |
| 2. | FS | 0.156 | 22 | 37 |
| 3. | FS + 1.5% PE | 0.261 | 104 | 59 |
| 4. | FS + 1.5% PE + | 0.259 | 103 | n.d. |
| | 100 mg GCBE | | | |
| 5. | FS + 1.5% PE + | 0.273 | 113 | 62 |
| | 200 mg GCBE | | | |

equivalents (TE).

The above results indicate that addition of 1.5% Concord grape pomace extract is sufficient to increase both the total phenolic antioxidant concentration and the ORAC values to levels at least 100% greater than the reference beverage (Welch's 100% Concord grape juice).

It is commercially important to be able to pasteurize such beverages and package them in clear bottles and other containers, e.g., clear PET plastic bottles, to permit shelf storage and sale of the beverages at room temperature as well as under refrigeration. Accordingly, sample #5 above [a Concord grape juice further containing ascorbic acid, 40 mg per 240 ml serving, in addition to Concord grape pomace extract and green coffee bean extract] was subjected to pasteurization at 185° C. for 1 minute to determine whether these ingredients are adequately heat-stable when combined. Immediately following pasteurization, PET bottles were hot-filled with the juice, and the bottles cooled and stored at room temperature. The juice remained free of precipitate, and the beverage maintained over 90% of its original phenolic antioxidant content as monitored by the F-C assay of total phenols both before and after pasteurization. In fact, as much as 95% or more of the original total phenolic content of such beverages could be maintained through pasteurization.

### EXAMPLE 10

### Blended Grape Juice Fortified with Concord Grape Pomace Extract and GOBE

A 100% grape juice blend (Fruit Smart, Prosser, Wash.) including between 67% and 75% Concord grape juice and 25%-33% white grape juice (16 Brix final) was supplemented with 1.5% by weight Concord grape pomace extract (see Example 2), green coffee bean extract (GCBE, 150 mg per 8 oz serving), 0.1% Concord grape essence (for flavor and aroma) and 40 mg ascorbic acid per 8 oz. serving. Again, the GCBE was found to reduce and help mask the astringency contributed by the pomace extract, while contributing its own polyphenolic antioxidants to the grape juice. The total phenolic antioxidant content of this antioxidant extract-fortified juice as determined by the F-C assay was 0.38% GAE, while both the initial Fruit Smart Concord 100% grape juice blend as well as Welch's Concord 100% grape juice blend both measured 0.22% GAE. Thus, the antioxidant fortification increased the phenolic content 72%.

### EXAMPLE 11

### Tea Fortified with Concord Grape Pomace Extract and Pomegranate Extract

A commercially bottled green tea (Snapple Beverage Group, White Plains, N.Y.) with an ORAC value of approximately 25, containing principally catechin-derivative polyphenolic antioxidants, was fortified with 1% by weight Concord grape pomace extract and 160 mg per serving pomegranate extract as described in Example 8. A small amount of tamarind extract in addition to either L-theanine (20 mg per serving) or green coffee bean extract (Vidya Herbs, Inc., 50 mg per serving) was added as flavoring enhancers. The resulting beverage had an excellent flavor, a somewhat purple color, and had an ORAC value of 49. This antioxidant level represented essentially a 100% increase over the initial value of the tea (ORAC 25) tested in the same experiment.

### EXAMPLE 12

### Tea Fortified with Vineferous Grape Seed Extract and Green Coffee Bean Extract

The same green tea used in Example 11 (Snapple Beverage Group, White Plains, N.Y.) was supplemented with 0.2% by weight of Activin® brand grape seed extract (Vitis vinifer) obtained from Natrol, Inc. (Chatsworth, Calif.), a tan/brown lightly colored water-soluble powder rich in proanthocyanidin polyphenolics, and having an ORAC value of approximately 13,000 units per gram. The powder has been reported to contain between 80% and 95% phenolics as gallic acid equivalents. The 0.2% by weight supplement contributed approximately 26 ORAC units per gram of beverage, resulting in over a 100% increase in antioxidant level. As an additional polyphenolic antioxidant and to correct any astringent taste, green coffee bean extract (150 mg per serving) was added (see Example 9). The resulting beverage had an excellent color and flavor, and had an ORAC value of 51, achieving essentially a 100% increase over its initial value (ORAC 25) for the base tea that was tested in the same study. This beverage had a conventional tea-like color that differed from the purple color contributed by grape anthocyanins in Example 9.

Additional tea beverages were prepared using Lipton (Unilever Company, Englewood Cliffs, N.J.) tea bags brewed in 8 oz. hot water (10 minute brewing at 85° C.). Tea bags contained approximately 2.2 g of either green tea or black tea as described elsewhere herein. These teas are reported by Lipton to provide 190 mg and 175 mg of flavonoids, respectively, per serving. Based upon an 8 oz (240 g) serving, these teas contain concentrations of 0.079% and 0.073% by weight flavonoids.

As above, grape seed extract was added to the teas. In this case, 0.1% by weight of the Activin® brand grape seed extract was added to each tea beverage. This level of extract was sufficient to increase the total polyphenolic concentration of the teas by more than 100%. Again, green coffee bean extract (150 mg per serving) was added to reduce astringency and thereby improve palatability.

### EXAMPLE 13

### Comminuted Heat-Processed Seedless Red Grape Sauce, and Release of Antioxidants Therein

In recent years, seedless whole red grapes have become increasingly popular in the American marketplace, and may soon overtake the seedless green Thompson grape that has been popular for many years. Varieties of the seedless red grape include the Red Flame, the Ruby Seedless, and the Black Beauty. In North America, seedless whole red grapes are available from Chile in the winter and California, Oregon and Washington in the summer.

A heat-processed grape sauce is based upon blade-shearing or grinding whole seedless red grapes, in which both the skin and pulp are comminuted and reduced to fragments of a size determined by the level of shear applied to the grapes. The resulting grape mixture is very palatable and pleasantly sweet even without the further addition of optional natural or artificial sweetener. The mixture is thickened to form a sauce, preferably by adding about 0.5% to about 2% by weight pectin, preferably about 1% by weight pectin. Given the low level of solids (see below) and the natural acidity of the liquid grape mixture, the selection of an amidated low ester pectin is beneficial and functional (e.g., SF 560 pectin from Danisco Ingredients USA, Inc., New Century, Kans.).

The texture of such a pectin-thickened red grape sauce, produced by low shearing action (e.g., using a “grinding” or blade “chopping” machine), is very pleasant and somewhat reminiscent of a cranberry sauce, but the mouth feel of the grape skin is subtle when compared to the thick cranberry skin. By contrast, high shear action (e.g., using high speed blade blending), produces a fine particulate sauce similar in texture to a fruit mousse. Both of these grape sauces have a more subtle flavor than cranberry sauce, and are sweeter (without sugar added) and less acid-tasting than cranberry.

Approximately 1 pound (450 g) of seedless Chilean Red Flame grapes were washed and blended in a Waring blender at low speed for 20-30 seconds to produce a coarsely ground or “chopped” grape mixture. Another pound of grapes was blended at high speed for a similar interval to produce a finely “blended” suspension of comminuted grape particles. A small portion of each fluid mixture was weighed on aluminum foil, then dried in an oven at 110° C. and re-weighed to determine water loss (78%) and solids content (22%) of the grape mixtures. A 50 cc sample of the blended grape mixture was incubated in a boiling water bath at 100° C., and 1 cc aliquots were removed at one minute intervals. These aliquots were promptly centrifuged to provide a series of clear supernatants that were assayed for polyphenolic antioxidant content (as gallic acid equivalents or GAE units using the Folin-Ciocalteau assay described previously). In this assay, an O.D. 760 nm reading of 0.30 corresponded to 2 μl of 1.00 mg/ml gallic acid (0.2 GAE units). The following O.D. readings were obtained as the 100° C. incubation continued, measuring the polyphenolic levels in the supernatants from successively centrifuged samples of the grape mixture. 2 μl Samples were assayed:

| Duration of Heating | |
|---|---|
| Sauce (minutes) | O.D. 760 nm readings |
| Zero | 0.19 |
| 1.0 | 0.30 |
| 2.0 | 0.34 |
| 4.0 | 0.37 |
| 6.0 | 0.44 |
| 8.0 | 0.48 |
| 10.0 | 0.50 |
| 15.0 | 0.52 |

By comparison, a 2 μl sample of Welch's Concord 100% grape juice registered 0.72. This study demonstrated that 4 minutes of heating at 100° C. doubled the level, and 10-15 minutes heating nearly tripled the level of polyphenolic antioxidants released into the soluble aqueous phase of the grape sauce. Thus, a sufficient period of heating is required for releasing phenolic antioxidants from the grape skin and other grape solids.

### EXAMPLE 14

### Antioxidant-Fortified, Astringency-Compensated Red Grape Sauce

Heat-processed comminuted seedless red grape sauces (see Example 13) were fortified with increasing levels of pomace extract from Concord grapes (Fruit Smart, Inc., Prosser, Wash.) as described elsewhere herein. When the level of added pomace extract reached a certain level (e.g., greater than 2% by weight), the grape sauce became noticeably astringent.

Seedless red grape sauces were prepared as described above in Example 13. Grape sauce mixtures were heated for 15 minutes and then supplemented with increasing percentages by weight of Concord pomace extract. Samples of the pomace extract-supplemented sauces were centrifuged to provide clear supernatants that were assayed for polyphenolic content (2 μl samples assayed). The O.D. 760 nm readings (Folin-Ciocalteau assays) are provided as follows: Grape sauce before heating: 0.15; Grape sauce after 15 minutes heating: 0.45. By comparison, the same amount (2 μl) of Welch's Concord 100% grape juice: 0.61. The O.D. 760 nm readings for the pomace-supplemented heated sauces were as follows:

| Pomace Extract | |
|---|---|
| Added (w/w) % | O.D. 760 nm readings |
| Zero | 0.45 |
| 1.0% | 0.58 |
| 1.5% | 0.66 |
| 2.0% | 0.76 |
| 2.5% | 0.90 |
| 3.0% | 0.95 |

The above results indicate that addition of 2.5%-3.0 pomace extract (e.g., a 68 Brix Concord pomace extract) can be used to at least double the level of polyphenolic antioxidants over the endogenous level present in the heated seedless red grape sauce. When 3% by weight Concord grape pomace extract was added to both the coarse and finely blended heated grape sauces in Example 13, unacceptably astringent-tasting sauces resulted. However, when 75 mg green coffee bean extract powder (Vidya Herbs, Irvine, Calif.) was dissolved and added to 4 oz. servings of the pectin-gelled sauces, the astringency was greatly diminished, and the sauces became very palatable.

This astringency compensation effect was at least as dramatic as previously noted for grape juice fortified with pomace extract, and for black and green teas (Camellia senensis) that had been fortified with grape seed extract (ActiVin® extract, San Joaquin Valley Concentrates). Similar methods to those described above can be used to produce polyphenolic antioxidant-fortified fruit preserves and jams, providing that a natural and/or artificial sweetener is added in greater amounts appropriate for such products.

### EXAMPLE 15

### Antioxidant-Fortified Red Grape Sauce Containing Concord Grape Pomace Extract and Camellia sinensis Extract

The heat-processed (15 minutes 100° C.) coarsely blended seedless red grape sauce described above in Examples 13 and 14 was fortified with 2% by weight pomace extract from Concord grapes (Fruit Smart, Inc., Prosser, Wash.) and Camellia senensis green tea extract. The sauce was gelled using an amidated low ester pectin (SF 560 pectin, Danisco Ingredients USA, Inc., New Century, Kans.) at a concentration of 4 g to 5 g pectin per pound of grape sauce.

The pectin was introduced into the sauce by pre-dissolving the pectin in 100 g of extra strength green tea. This green tea had been prepared ahead of time by brewing 4 g of Lipton Green Tea (equivalent of 2 servings) with 120 g water. The grape sauce was formulated using 350 g blended red grapes, 9 g pomace extract and 100 ml extra strength green tea extract. The resulting gelled sauce tasted sweet and not astringent. If the concentration of pomace extract were increased to 3% by weight or more, then green coffee bean extract (approximately 75 mg per 4 oz of sauce) could be added to offset astringency.

### EXAMPLE 16

### Antioxidant-Enriched Processed Fruit Leathers

Fruit leathers are dried fruit products that are made by placing a uniform coating of semi-liquid or at least flowable pureed fruit material (comminuted or blended/sheared fruit solids plus juice) onto a flat surface and removing most of the free water (e.g., by evaporative drying). The fruit puree is poured, cast or extruded about ⅛-inch (about 3 mm) thick, onto a drying surface. The drying time varies greatly depending upon the method used. Suitable dryness can be judged when the fruit leather does not show indentation when pressed. When dry, the fruit leather can be peeled from a plastic drying surface or plastic film and rolled up. Thus, the product has become known as fruit leather “roll-ups”. Residual fruit pulp from making jellies, or alternatively whole fruit can be blended and made into fruit leather. Fruit leathers can be made without sugar (or with artificial sweetener) as a healthy alternative to sugared snacks and desserts.

Seedless grapes, strawberries and other fruits that possess no seeds or inedible skins are preferred starting materials, although some fruit with skin and seeds, e.g., apples, are worthwhile peeling and de-seeding for use in fruit leathers. Alternatively, canned or frozen fruit can be utilized. Fruit material, free of any inedibles, is pureed until smooth. To increase the level of beneficial polyphenolic antioxidants, a concentrated Concord grape pomace extract (e.g., 68 Brix pomace extract described above) can be added to the fruit puree material at a level of between 1% and 4% by weight.

As in previous Examples, when elevated levels of polyphenolic extracts are added (e.g., 2%-4% pomace extract), undesirable taste astringency can be apparent, and is offset by adding a compensating agent such as green coffee bean extract (see above, e.g. 0.05%-0.1% by weight based upon the weight of fruit puree). To help prevent premature oxidation of polyphenolic antioxidants in the finished product, approximately 100-400 mg ascorbic acid is preferably added for each pound of fruit puree. Optional sweetener can also be added to taste (e.g., approximately 0.25-0.5 cups corn syrup or honey for each pound of fruit). However, saccharin or sucralose-based artificial sweeteners can alternatively be used to reduce tartness without adding calories.

The fruit purees are typically dried slowly on large plastic or plastic film-lined sheets in low-heat ovens (e.g., 140° F.). However, in the present invention, to protect polyphenolic antioxidants from premature oxidation and thermal decomposition, vacuum drying is preferred. Other dehydrating methods that avoid sustained exposure to heat and air (oxygen) can be used.

Spices as well as other flavorings and garnishes can be added to the fruit purees before drying. The spices can include, for example, allspice, cinnamon, cloves, coriander, ginger, mace, mint, nutmeg or pumpkin pie spice. The garnishes can include, for example, shredded coconut, chopped dates, other dried chopped fruits, granola, miniature marshmallows, chopped nuts, chopped raisins, poppy seeds, sesame seeds or sunflower seeds.

### EXAMPLE 17

### Antioxidant-Enriched Processed Fruit Bars

Fruit bars are baked soft cookie/cake-like pastries filled with fruit jam. The jam filling is thick and remains in place within the pastry jacket. The prototypical fruit bar is the fig bar. It is commonly recognized and known in the U.S. as the Fig Newton™ that was created in 1891 by Joshua Josephson of the Kennedy Biscuit Company in Massachusetts. Several other fruit bars have been commercialized, including strawberry, cherry, apple, and raspberry fruit varieties.

Polyphenolic antioxidant-enriched fruit purees are produced as in Example 165, e.g., Concord grape pomace extract-supplemented seedless red grape purees, preferably supplemented with green coffee bean extract to compensate for astringency. The average particle size in the puree can be controlled and varied by the degree of shear applied to the fruit mixture. As in Example 16, the water content of the fruit puree is reduced, but to a level that provides a fruit jam suitable for use as fruit bar filling rather than a fruit leather.

A machine capable of producing the cookie consists of a funnel within a funnel, where the inner funnel contains the fruit filling, and the outer funnel contains the cookie dough. The machine extrudes the filled cookie, which can then either be baked and cut into fruit bar-sized pieces, or alternatively sliced first and then baked.

### EXAMPLE 18

### Antioxidant-Enriched Frozen Fruit Sorbet and Popsicles

Berry fruit including raspberries, strawberries, blueberries, cranberries, blackberries, currants and others are known to contain substantial levels of polyphenolic antioxidants. A high quality commercially manufactured frozen raspberry fruit sorbet (Sharon's Sorbet Inc., New York, N.Y.) containing only blended raspberries, water, cane sugar, lemon juice and pectin was purchased. The sorbet was permitted to warm slightly until it became soft enough to blend with other ingredients. When it reached a stirrable consistency, 2%, 3% and 4% by weight levels of Concord grape pomace extract (see above) were added, blended with the sorbet, and tasted. The 2% pomace extract level was essentially undetectable on the palate. The 3% and 41 levels tasted surprisingly good, with only a mild to moderately astringent aftertaste becoming apparent with 4% pomace extract.

It is possible that sorbet, with its combination of sweetness and cold, reduces the perception of astringency on the palate. This permits approximately two-fold higher levels of the Concord grape pomace extract to be added to raspberry sorbet than to Concord grape juice, for example, without tasting overly astringent. When 4% pomace extract was added to the raspberry sorbet, moderate astringency was again successfully diminished by adding approximately 20 mg of green coffee bean extract (Vidya Herbs, see above) per ounce of sorbet. Similar results occur in formulating antioxidant-fortified frozen fruit popsicles that closely resemble fruit sorbet in flavor and composition.

Unless otherwise defined herein, all terms have their ordinary meanings as understood by one of ordinary skill in the field to which the invention pertains. The use of the article “a” or “an” is intended to include one or more. All patents, patent applications and publications cited in the specification are indicative of the levels of skill of those skilled in the art to which the invention pertains. All patents, patent applications and publications cited in this disclosure are incorporated by reference to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications can be made to the invention disclosed herein without departing from the scope and spirit of the invention. For example, complementary polyphenolic antioxidant extracts that are constituted using other fruit or vegetable sources not listed herein, or complementary polyphenolic antioxidant extracts incorporated into various polyphenolic-rich beverages not listed herein, or a combination of two or more complementary polyphenolic antioxidant sources used at the concentrations described to produce a beverage having a diverse and balanced combination of antioxidants, fall within the scope of the present invention. Thus, such additional embodiments are within the scope of the present invention and the following claims.

The invention illustratively described herein suitably can be practiced in the absence of any element or elements, limitation or limitations which is not specifically disclosed herein. Thus, for example, in each instance herein any of the terms “comprising”, “consisting essentially of” and “consisting of” can be replaced with either of the other two terms. The terms and expressions that have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed can be resorted to by those skilled in the art, and that such modifications and variations are considered to be within the scope of this invention as defined by the appended claims.

1. A comestible composition that comprises a precursor edible product having dissolved or dispersed therein (i) an astringent amount of exogenous polyphenolic antioxidant, and (ii) at least one astringency compensating agent present in a concentration sufficient to mask the astringency contributed by the exogenous polyphenolic antioxidant.

2. The comestible composition according to claim 1, wherein said precursor edible product is free of endogenous polyphenolic antioxidant.

3. The comestible composition according to claim 1, wherein said precursor edible product contains endogenous polyphenolic antioxidant.

4. The comestible composition according to claim 3, wherein said precursor edible product that contains a measurable level of endogenous polyphenolic antioxidants is selected from the group consisting of a jam, a jelly, a fruit preserve, a fruit leather, a fruit sauce, a frozen fruit dessert, a fruit juice, a tea and combinations thereof.

5. The comestible composition according to claim 1, wherein said exogenous polyphenolic antioxidant is present in said comestible composition at a concentration of about 0.08 to about 0.50 gallic acid equivalent units.

6. The comestible composition according to claim 1, wherein said astringency compensating agent is selected from the group consisting of L-theanine, a soluble cyclodextrin, green coffee bean extract, roasted coffee bean extract, chlorogenic acid and mixtures thereof.

7. A comestible composition that comprises a precursor edible product having dissolved or dispersed therein (i) an exogenous polyphenolic antioxidant present in said comestible composition at a concentration of about 0.08 to about 0.50 gallic acid equivalent (GAE) units, and (ii) at least one astringency compensating agent selected from the group consisting of L-theanine, a soluble cyclodextrin, green coffee bean extract, roasted coffee bean extract, chlorogenic acid and mixtures thereof present in a concentration sufficient to mask the astringency contributed by the exogenous polyphenolic antioxidant.

8. The comestible composition according to claim 7, wherein said precursor edible product contains endogenous polyphenolic antioxidant present at least at about 0.05% by weight.

9. The comestible composition according to claim 8, wherein said precursor edible product that contains a measurable level of endogenous polyphenolic antioxidants is a non-beverage food product or a beverage.

10. The comestible composition according to claim 9, wherein said precursor edible product is a beverage that is a fruit juice, a tea or a combination thereof.

11. The comestible composition according to claim 10, wherein said beverage is a fruit juice.

12. The comestible composition according to claim 11, wherein said fruit juice is a grape juice.

13. The comestible composition according to claim 9, wherein said precursor edible product is a non-beverage food that is selected from the group consisting of a jam, a jelly, a fruit preserve, a fruit sauce, a fruit bar, a fruit leather, a frozen fruit sorbet, a fruit flavored ice cream, and a frozen fruit popsicle.

14. The comestible composition according to claim 1, wherein said exogenous polyphenolic antioxidant is provided by an extract prepared and selected from the group consisting of grape pomace, grape seed pomace, grape skin pomace, green tea pomace, green coffee bean pomace, tropical oil palm fruit pomace, pomegranate pomace, acai pomace, blackberry pomace, black currant pomace, bilberry pomace, blueberry pomace, cherry pomace, chokeberry pomace, cranberry pomace, elderberry pomace, gooseberry pomace, raspberry pomace, strawberry pomace and combinations thereof.

15. The comestible composition according to claim 12, wherein said exogenous polyphenolic antioxidant is selected from the group consisting of grape pomace extract, grape seed extract, grape skin extract, green tea extract, green coffee bean extract, extract of fruit of the tropical oil palm, pomegranate extract, acai, blackberry, black currant, bilberry, blueberry, cherry, chokeberry, cranberry, elderberry, gooseberry, raspberry, strawberry and combinations thereof.

16. The comestible composition according to claim 15, wherein said grape pomace extract is an extract of a grape species that is different from the species of the grape juice.

17. The comestible composition according to claim 16, wherein said precursor edible product is grape juice, said exogenous polyphenolic antioxidant is grape pomace, and said grape pomace is an extract of a grape species that is different from the species of the grape juice.

18. The comestible composition according to claim 8, wherein said exogenous polyphenolic antioxidant increases the polyphenolic antioxidant concentration of said precursor edible product by at least 40%.

19. The comestible composition according to claim 7, wherein said exogenous polyphenolic antioxidant is present in said comestible composition at a concentration of about 0.12 to about 0.28 GAE units.

20. A method of producing a polyphenolic antioxidant-enhanced comestible composition from an edible product, said method comprising:
(i) providing a precursor edible product; and
(ii) dissolving or dispersing (a) an astringent amount of exogenous polyphenolic antioxidant and (b) at least one astringency compensating agent in a concentration sufficient to mask the astringency contributed by the exogenous polyphenolic antioxidant in said precursor edible product to form the comestible composition, wherein (a) and (b) are dissolved or dispersed separately or together in said precursor edible product.

21. The method according to claim 20, wherein said precursor edible product is free of endogenous polyphenolic antioxidant.

22. The method according to claim 20, wherein said precursor edible product contains endogenous polyphenolic antioxidant.

23. The method according to claim 22, wherein the amount of said exogenous polyphenolic antioxidant is sufficient to increase the polyphenolic antioxidant concentration of said precursor edible product at least 40%.

24. The method according to claim 20, wherein (a) and (b) are dissolved or dispersed separately in said precursor edible product.

25. The method according to claim 24, wherein (a) is dissolved or dispersed before (b).

26. The method according to claim 20, wherein the ORAC value of said precursor product is at least 20, and the ORAC value of said enhanced beverage is increased by at least 40%.

27. The method according to claim 20, wherein said precursor edible product is a beverage.

28. The method according to claim 27, wherein said beverage is a fruit juice.

29. The method according to claim 27, wherein said beverage is a tea.

30. The method according to claim 20, wherein said precursor edible product is a non-beverage food product.

31. The method according to claim 30, wherein said non-beverage food product is a fruit leather.

32. The method according to claim 30, wherein said non-beverage food product is a fruit sauce.

33. The method of claim 20, wherein said exogenous polyphenolic antioxidant is provided by an extract selected from the group consisting of grape pomace, grape seed pomace, grape skin pomace, green tea pomace, green coffee bean pomace, tropical oil palm fruit pomace, pomegranate pomace, acai pomace, blackberry pomace, black currant pomace, bilberry pomace, blueberry pomace, cherry pomace, chokeberry pomace, cranberry pomace, elderberry pomace, gooseberry pomace, raspberry pomace, strawberry pomace and combinations thereof.

34. The method of claim 20, wherein said astringency compensating agent is selected from the group consisting of L-theanine, a soluble cyclodextrin, green coffee bean extract, roasted coffee bean extract, chlorogenic acid and mixtures thereof.

35. A polyphenolic antioxidant and astringency compensating agent premix, that comprises
a concentrated fruit or vegetable-derived extract containing polyphenolic antioxidant that when mixed with a palatable food causes that food to have an astringent taste; and
at least one astringency compensating agent present in an amount sufficient to mask the astringent taste of said polyphenolic antioxidant.

36. The premix of claim 35, wherein said concentrated fruit of vegetable-derived extract is a grape pomace extract, grape seed extract, grape skin extract, or a combination thereof.

37. The premix of claim 35, wherein said astringency compensating agent is or is extracted from a green coffee bean extract.

38. The premix of claim 35 that further includes an effective amount of a protective agent that protects polyphenolic antioxidants from premature oxidation.

39. A seedless grape sauce comprising comminuted whole seedless grapes and an optional thickening agent, and having the viscosity at ambient room temperature of about that of an apple sauce, said seedless grape sauce containing:
(i) a pourable liquid portion and a relatively solid portion that can be separated from each other by centrifugation or filtration, and upon separation of the liquid and relatively solid portions, said separated liquid portion having a GAE unit concentration value of at least 0.1,
(ii) grape skin pieces that are less than about one-quarter inch in the longest dimension, and
(iii) grape skin polyphenolic antioxidants,
said seedless grape sauce being free of grape seed antioxidants.

40. The seedless grape sauce according to claim 39 that is thickened with a polysaccharide food thickener.

41. The seedless grape sauce according to claim 40, wherein said polysaccharide food thickener is a pectin.

42. The seedless grape sauce according to claim 39, wherein said seedless grape is red or purple.

43. The seedless grape sauce according to claim 39, wherein said separated liquid portion has a GAE unit concentration value of at least 0.15 GAE units.

44. The seedless grape sauce according to claim 39, wherein said grape skin pieces are less than about one-eighth inch in the longest dimension.

45. The seedless grape sauce according to claim 39, wherein said grape sauce has endogenous grape skin polyphenolic antioxidants present in said pourable liquid portion at a concentration of about 0.1 to about 0.5 GAE units.

46. The seedless grape sauce according to claim 39, wherein an exogenous polyphenolic antioxidant is present in said comestible composition at a concentration of about 0.08 to about 0.50 GAE units.

47. The seedless grape sauce according to claim 46, further comprising at least one astringency compensating agent present in a concentration sufficient to mask the astringency contributed by said exogenous polyphenolic antioxidant.
